(19) United States
(12) Patent Application Publication
(10) Pub. No.: US 2016/0038788 A1
(43) Pub. Date: Feb. 11, 2016

(54) PERFORMANCE MONITORING SYSTEMS AND METHODS FOR EDGING SPORTS

(71) Applicant: BLUR SPORTS INC., Penticton (CA)

(72) Inventors: Scott McMillan, Penticton (CA); Ernie Janzen, North Vancouver (CA); Matt Greig, Burnaby (CA); Yong Gui, Burnaby (CA); Minghao Hu, Zhejiang (CN); Joe Newton, North Vancouver (CA)

(21) Appl. No.: 14/764,911

(22) PCT Filed: Feb. 6, 2014
(86) PCT No.: PCT/CA2014/000082

§ 371 Date: Sep. 28, 2015

Related U.S. Application Data
(60) Provisional application No. 61/761,538, filed on Feb. 6, 2013.
(60) Provisional application No. 61/886,432, filed on Oct. 3, 2013.

(51) Int. Cl. A63B 24/00; A63B 69/18; G01L 5/00; A43B 5/16; A43B 3/00; G06F 19/00; A63B 69/00; A43B 5/04

(52) U.S. Cl. CPC A63B 24/0062; A63B 69/0022; A63B 69/18; A63B 69/0093; A43B 5/04; A43B 5/0401; A43B 5/16; A43B 3/0005; G06F 19/345; G01L 5/00; A63B 2220/51; A63B 2220/40; A63B 2220/17; A63B 2220/56; A63B 2220/833

(57) ABSTRACT

A performance monitoring system and method for edging or near-edging sports includes a pair of measurement apparatus associated with each foot or of an athlete. Each measurement apparatus includes at least one sensor, adapted to cooperate with the corresponding foot or boot and the corresponding surface-engaging equipment to measure and provide at least force data exerted on said surface-engaging equipment. A data receiver cooperates with each sensor to receive said data and to communicate said data to a data processor. The data processor is adapted to determine from said data, for each sensor, at least the following derived characteristics: force over time, a peak force, delta time, and corresponding explosiveness. Feedback of the characteristics is provided to a user.

### FIELD OF THE INVENTION

The present invention relates to body-worn performance monitoring devices for sporting activities, and more particularly to foot-worn performance monitoring device for monitoring leg-exerted forces in edging sports such as hockey, figure skating, speed skating, cross-country skiing, downhill skiing and snowboarding.

### BACKGROUND OF THE INVENTION

Athletes are interested in improving their performance. To do so they find it useful to use sport monitoring devices to attain feedback about their performance. The feedback can provide assessments of their technique, workload and biometrics during a game or in practice. The examination of forces that an athlete produces provides valuable information related to their technique and workload. It is thus an object to provide for examining forces in the field of play for athletes and practitioners.

In the prior art, force platforms are available but generally require that an athlete simulate sport movements in a laboratory where the platform is installed. Other platforms have been installed in the field of play but are very expensive to setup and take a lot of time to operate.

Force platforms also need to be mounted to a surface or below the surface. This means that the athletes are only on the force platform for a few seconds as they pass over it. This is good for focused research trials but impractical for regular training in real sporting environments.

In the prior art, insole pressure measurement systems indirectly measure the vertical forces under an athlete's foot as they perform movement. They are unable to measure side to side or fore-aft forces, otherwise termed shear forces. Insole pressure mats are placed under the foot and in the boot. This can limit the amount of space needed for the athlete's foot. Force calculations from pressure measurements are not as accurate and reliable as using force platforms. Durability of the pressure mats can vary greatly depending on the manufacturers design.

Coaches work with hockey players regularly to improve their skating technique and conditioning without quantitative feedback. Sport performance specialists on a team or working independently may use video analysis and timing systems to measure joint angles and skating speed respectively.

Kinematic measurements are also valuable to athletes. Sensing motion can provide simple feedback such as playing time or more granular feedback about how fast an athlete is moving. Angular position data can also describe the athletes' movement or movement of their sports equipment relative to the ground. For instance, edge angles in skating and skiing are important to control in order to move faster, slower or change direction.

Kinematic and force measurements are valuable to know to determine an athletes' strengths and weaknesses, training program assessments of effectiveness, when to alter training, when to rest, readiness to play following injury, talent identification, assess motivation, assess workload, pace training and assign specific training parameters.

With the type of kinematic and kinetic measurement solutions described above, the athletes don't have a way to share quantitative data with others, whether friends and family or professional contacts such as coaches and scouts.

To Applicant's knowledge, to date no one has produced a commercially available force measurement hockey skate, figure skate, speed skate, ski or snowboard, and consequently it is also an object to provide same.

As listed in the list of Cited Publications below, McCaw (1984) notes that hockey skating performance research started in 1968 with thesis work by Lariviere. In his work, Lariviere associated greater skating velocity with larger angle of propulsion, smaller angle of forward lean and greater stride length. A number of film studies followed by a variety of researchers. This was summarized by McCaw, stating that players skated faster by using faster step rates and longer single support time without increases in step length. Also, hip and knee displacement and angular velocities increased with skill levels. Finally, an increased range of motion resulted from greater joint flexion prior to extension.

The kinetics (force measurements) of ice hockey skating may have its origins with work done by Halliwell (1977). Halliwell used a laboratory force platform and film analysis to better understand the amount of force skaters produced and how much force the knee joint was under during a simulated skate thrust. Since these force platforms are located in a laboratory they did not have the means to measure forces on the ice.

Speed skating researchers were the first to measure skating forces on the ice (Jobse, 1990). They built a load cell between the boot of the skate and the blade. Using the same or somewhat similar design their work actually led to the development of a new speed skate design called the klap-skate (Houdijk, 2001). Updated versions of that design are still used today by Olympic speed skaters. Examples of how this technology advanced scientific understanding and improved speed skating performance can be found in studies that researched skating mechanics, metabolic demands of skating and pacing strategies (Houdijk, 2000; Houdijk, 2001; Yuda et al, 2004).

Stidwill (2009) reviewed skating force measurement systems in his masters thesis at McGill. He mentioned that Gagnon and Lamontagne in 1983 were the first to measure ice hockey skating forces during a parallel skating stop. Gagnon's and Lamontagne's design involved modifying traditional tube (metal) skate holder and subsequently adhering strain gauges directly to them.

Stidwill et al. (2010a) published a technical note based on Stidwill's thesis work. They outline a much different approach than previous researchers to measure force on the skate. Instead of building a load cell to integrate into the skate, or attaching it to metal tube skates, they adhered multiple strain gauges to the inside of present-day plastic blade holders. Using these skates, Stidwill (2011) [REFERENCE MISSING] did a comparison of on-ice skating to treadmill (synthetic) skating (Stidwill, 2010b) and others at McGill went on to study the forces during a change of direction (Fortier, 2010), and skating cross-over mechanics (Robert-Lachaine, 2011). These studies were supported by BAUER™ and usually included a comparison of varying skate designs.

There have been potential limitations with the technical designs and equipment used to measure forces in the aforementioned works. The speed skating force system design used by Jobse (1990) and used in multiple studies including Houdijk (2000, 2001) was heavy, required a wired backpack and was fragile. They system was unable to measure medial-lateral forces. Yuda (2005) used piezoelectronic load cells which are reasonably small but are expensive and require significant electronics worn by the skater in a backpack as well. These designs were also specifically made for speed skate, not hockey skates.

Gagnon and Lamontagne's hockey skate force measurement system in 1983 was done on traditional tubed skates. In the mid 80's players began using plastic blade holders thus rendering their research methods obsolete. McGill's research based design can be applied to present day skates but has not demonstrated reasonable precision and reliability. High levels of precision when placing sensors on unpredictable materials such as plastic (ie. they do not deform predictably). Their system was also adhered to the exterior of the skate which would easily be damaged in regular hockey practice or games. Xsens™ (Enschede, Netherlands) sells a ForceShoe which provides 3D force, torque and kinematics under the sole of a sandal (http://www.xsens.com/en/general/forceshoe). The force structure is sandwiched between two carbon fibre plates that are adhered to the sole of the shoe. This is a design that is neither technically feasible nor durable enough for sport use. The data is sent through a wired connection to a wireless hub on the athlete.

Commercial sport monitoring devices in other sports are known. Running based sports are using GPS and accelerometer commercial systems to attain data on training and game performance. Unfortunately, GPS cannot be used indoors and current accelerometer systems cannot be used on ice skates do to the differences in motion of the athlete. An independent skating accelerometer system would require substantially new algorithm development. Such a system could provide some measurements that a force system can such as step time, stride time and time to peak. However, they do not provide a measure of how hard a skater is pushing and how that skater is applying that force.

Cycling based sports use power meters. These power meters measure forces and velocity near the pedal, crank arm, spider or hub to derive power. There are many manufacturers such as Quarg™ (Spearfish, SD, USA) and SRM™ (Hauptniederlassung, Germany) which provide commercial systems that are popular among competitive athletes. A cycling power meter cannot readily be used in ice hockey.

Applicant provides a true on-ice skate sensing system to players and teams.

In the prior art Applicant is aware of the following patents and published patent applications that may be relevant: U.S. Pat. Nos. 8,336,400, 8,011,242, US 2011/0166821, U.S. Pat. No. 8,165,844, US 2010/0063778, US 2009/0278791, U.S. Pat. No. 8,186,217, U.S. Pat. No. 7,171,331, U.S. Pat. No. 7,512,515, U.S. Pat. No. 7,698,101, U.S. Pat. No. 6,498,994, U.S. Pat. No. 7,813,887, US 2003/0017882, US 2007 0123389, U.S. Pat. No. 7,866,674, U.S. Pat. No. 7,162,392, U.S. Pat. No. 7,092,846, U.S. Pat. No. 7,072,789, U.S. Pat. No. 7,054,784, U.S. Pat. No. 7,623,987, US 2006 0015287, U.S. Pat. No. 7,927,253, US 20100292050, US 20120015779, US 20100292600, US 2012 0015778, U.S. Pat. No. 8,011,242, U.S. Pat. No. 8,006,574

### Cited Publications:

Jobse, H., R. Schuurhof, F. Cserep, A. W. Schreurs, and J. J. de Koning (1990). Measurement of push-off force and ice friction during speed skating. Int. J. Sport Biomech. 6:92-100.

Fortier, A (2010). Skating Mechanics of Change of Direction Maneuvers in Hockey Players. M.Sc Thesis (Kinesiology and Physical Education), McGill University.

Halliwell, A. A., (1977). Determination of muscle, ligament and articular forces during a simulated skating thrust. M.PE Thesis (Physical Education and Recreation), University of British Columbia.

Houdijk H, de Koning J J, de Groot G, Bobbert M F, van Ingen, Schenau G J (2000) Push-off mechanics in speed skating with conventional skates and klapskates. Med Sci Sports Exerc 3:635-641.

Houdijk, H., de Koning, J. J., de Groot, G., Bobbert, M. F. and van Ingen Schenau, G. J. (2000). Push-off mechanics in speed skating with conventional skates and klapskates. Med. Sci. Sports Exerc., Vol. 32, No. 3, pp. 635-641.

Yuda, J., Yuki, M., Aoyanagi, T., Fugi, N., Michiyoshi, A. (2004). Changes in Blade Reaction Forces During the Curve Phase Due to Fatigue in Long Distance Speed Skating, International Journal of Sport and Health Science, Vol. 2, 195-204.

de Koning, Jos. J., Carl Foster, Joanne Lampen, Floor Hettinga, and Maarten F. Bobbert (2005). Experimental evaluation of the power balance model of speed skating. J Appl Physiol 98: 227-233.

McCaw, S. T. (1984), A Biomechanical Comparison of Novice, Intermediate and Elite Ice Skaters, MA Thesis (Education), McGill University.

Robert-Lachaine, Xavier, (2011) Force measurement and ankle motion of the forward skating and crossovers with a standard hockey skate and a modified hockey skate, M.Sc Thesis (Kinesiology and Physical Education), McGill University.

Stidwill, T. J. (2009). Comparison of forward hockey skating kinetics and kinematics on ice and on synthetic surfaces by means of a customized force measurement system and electromyography. M.Sc (Kinesiology and Physical Education), McGill University.

Stidwill T J, Pearsall D J, Dixon P, Turcotte R, (2010a) Force Transducer System for Measurement of Ice Hockey Skating Force, Sports Engineering 12:63-68.

Stidwill T J, Turcotte R, Pearsall D J, (2010b) Comparison of Skating Kinetics and Kinematics on Ice and on a Synthetic Surface, Sport Biomechanics 9(1): 57-64.

Thermablade (2011). Corporate Investor Presentation. Calgary, A B.

### SUMMARY OF THE INVENTION

According to a first aspect of the invention there is provided a performance monitoring system for edging sports in which a foot-worn boot attached to ground-engaging equipment is manipulated by a wearer of the boot to control digging of one of more edges of the ground-engaging equipment a ground surface beneath the wearer, the system comprising a pair of measurement apparatuses each comprising a load cell equipped with a upper and lower fastening mechanisms, whereby the load cell of each measurement apparatus is arranged for installation in a sandwiched condition between the boot and the ground-engaging equipment at a respective position underlying one of a forefoot area and a heel area of the boot to measure forces exerted by the wearer of the boot.

According to a second aspect of the invention there is provided a method of installing a performance monitoring system for edging sports in which a foot-worn boot attached to ground-engaging equipment is manipulated by a wearer of the boot to control digging of one of more edges of the ground-engaging equipment a ground surface beneath the wearer, the method comprising mounting a pair of a load cells in a position sandwiched between the boot and the ground-engaging equipment at respective positions arranged to underlie forefoot and heel areas of the boot to measure forces exerted by the wearer of the boot.

According to a third aspect of the invention there is provided a method of installing a performance monitoring system for edging sports in which a foot-worn boot attached to ground-engaging equipment is manipulated by a wearer of the boot to control digging of one of more edges of the ground-engaging equipment a ground surface beneath the wearer, the method comprising mounting a pair of a load cells in a position sandwiched between the boot and the ground-engaging equipment at respective positions arranged to underlie forefoot and heel areas of the boot to measure forces exerted by the wearer of the boot.

In a further aspect of the performance monitoring system according to the invention for edging or near-edging sports in which a pair of foot-worn boots are coupled to corresponding surface-engaging equipment which is manipulated by a wearer of the boots to control engaging of one or more edges or near-edges of the surface-engaging equipment with the surface beneath the wearer, may be characterized as including a pair of measurement apparatus, one measurement apparatus of said pair of measurement apparatus associated with each boot of said pair of foot-worn boots, each measurement apparatus of said pair or measurement apparatus comprising at least one sensor, wherein said at least one sensor is adapted to cooperate with the corresponding boot and the corresponding surface-engaging equipment to measure and provide data corresponding to at least forces exerted on said surface-engaging equipment by the wearer of said boots. A data receiver cooperates with each sensor to receive said data and to communicate said data to a data processor. The data processor is adapted to determine from said data, for each sensor, at least the following characteristics derived from said data: force over time, a peak force of said force over time, delta time of any one of said force over time, explosiveness corresponding to any one of said delta time. A feedback mechanism selectively provides at least a quantum of at least one of said characteristics to a user.

In a further aspect of the invention, a method is provided for use of the performance monitoring system, in all of its various aspects.

In some embodiments, such as may for example be used for hockey, the delta time corresponds to a step time.

The sensor may be chosen from the group comprising: strain gauge, accelerometer, gyroscope, magnetometer, pressure gauge. Each sensor may include separate sensors associated with a heel portion and a toe portion of each boot.

The characteristics may advantageously further include one or more of: power, stride rate, step time, angular roll displacement about a longitudinal axis of each boot, angular roll acceleration about said longitudinal axis, side-to-side force, angular acceleration in pitch between heel and toe, instantaneous force, average force, peak force, time to peak force, start time of movements, time between movements, impulse, side-to-side torque about said longitudinal axis, force vector, force vector components in direction of motion. The explosiveness characteristic may include rate of force development. The characteristics may further include a load distribution between heel and toe portions of each said boot. The characteristics may be adjusted for a body weight of the wearer. When the edging sport is for example, hockey, said processor may be adapted to determine one or more of said characteristics over three steps at said step times. The three steps may be for example measured from a zero velocity of said wearer.

In some embodiments the delta time of any one of said force over time is determined as a time interval between sensed vertical force loadings going to zero.

In edging sports, the edges of the surface engaging equipment may include a spaced-apart, substantially longitudially extending pair of edges under each boot, wherein the edges are adapted to cut into water when in one or more of its various states, excluding any gaseous states, and including snow or ice. In near-edging sports such as employing wheels, for example, in-line skates and skateboards, the edges of the surface engaging equipment are the perimeters of the wheels collectively referred to herein as edges. The edges may be divided by said processor into a plurality of virtual zones, and the processor is adapted to allocate the force distribution into those plurality of zones. The force vector characteristic may be allocated by said processor amongst said plurality of zones. Each pair of edges under each boot may be for example divided into four zones. Each zone may include corresponding sections of opposite edges of said pair of edges so as to result in said allocation amongst one or more of eight separate sections of said edges.

The processor may be adapted to count the start time of said movements characteristic so as to thereby count movements of the wearer and to derive a cumulative volume of movements characteristic of the wearer over time. The processor may be adapted to determine frequency of said movement of the wearer and to combine said frequency of said movements with said force characteristics to thereby determine an intensity characteristic. The magnitude of said intensity characteristic may become greater as an angular value of said angular roll displacement characteristic is increased when other of said characteristics remain substantially constant.

The sensor may be adapted to sense roll about three independent, orthogonal roll axes of each boot. The characteristics may then further include angular velocity and angular acceleration about each of said orthogonal roll axes. The processor may be adapted to associate an intensity characteristic which indicates a greater intensity of said intensity characteristic with greater angular velocities about said roll axes.

In an edging sport such as hockey, or in a near-edging sport, the processor may be adapted to correspond a quicker step time and such as stride rate to a greater intensity characteristic. The processor may be adapted to correlate said impulse characteristic with time so as to determine a net impulse and an associated performance level of the wearer.

In one preferred embodiment the processor has a memory device cooperating with said processor, and is adapted to use said angular displacement characteristic to determine a sway of the wearer. The processor may be further adapted, in cooperation with said memory device, to retain and compare a history of said sway of the wearer to thereby provide for correlation of said sway to injury causing events which have injured the wearer over said history. The injury causing events may include concussions.

The memory device may be adapted to store, for retrieval by said processor, historical records of one or more of said characteristics as measured by said sensors, and wherein said processor is adapted to provide one or more of the group of actions including: (a) monitor, (b) cause to be displayed, (c) determine trends in, (d) analyze, (e) analyze and/or trends in, and (f) report on, said historical records of said characteristics.

When the edging sport is for example, hockey, said processor may be adapted to determine one or more of said characteristics over three steps at said step times. The three steps may be for example measured from a zero velocity of said wearer.

The processor may be adapted to monitor historical records of one or more of said characteristics and to determine trends correlating to fatigue of the wearer. The fatigue may be from the group comprising: neuromuscular fatigue, metabolic fatigue. The fatigue may be caused by the onset of illness. The fatigue may be caused by a recurring injury.

The processor may be adapted to store historical records of one or more said characteristics and to selectively retrieve said historical records for comparison and analysis of trends in said records over time. A set of previous performance records of a third party may be provided and said historical records of said wearer compared and analyzed relative to said previous performance records of said third party. The previous performance records may be those of team-mates of the wearer. The previous performance records may be high performance standards to achieve, such as those set by a higher level athlete as compared to the wearer, for example those of a professional athlete.

The historical records may be from within the wearer's past performance within a time frame chosen from the group comprising: last practice performance, last performance in competition, season-to-date, last season, lifetime, duration of a membership of the wearer to a subscriber version of the system when the system described herein is provided to wearers and users on a subscription or other a pay-for-service basis in whole or in part.

As for example, when the edging sport is hockey, and a time-of-game clock and its corresponding clock data is provided in which the wearer is participating as a player, the processor may be adapted to determine and track one or more of said characteristics during said game in substantially near-to-real time and to provide feedback to a user of corresponding game data.

### BRIEF DESCRIPTION OF THE DRAWINGS

In the accompanying drawings, which illustrate exemplary embodiments of the present invention:

FIG. 1 is a side elevational schematic view of a first embodiment performance measurement system of the invention attached to a piece of sports equipment, particularly an ice hockey skate.

FIG. 2 is a bottom plan view of the blade holder of the ice hockey skate of FIG. 1, illustrating attachment of measurement system to the ice hockey skate.

FIG. 3 is a partial exploded view illustrating assembly of one of the measurement apparatuses of the system of FIG. 1 to the ice hockey skate.

FIG. 4 is an isolated plan view of a load cell platform of each measurement apparatus for measuring strain and subsequently determining the force the athlete is producing.

FIG. 5 is an isolated plan view of an adapter plate that attaches between the top piece of the sports equipment (e.g. ice skate boot) and the load cell platform.

FIG. 6 is a schematic diagram of the system's sensors and electrical components.

FIG. 7 is a schematic overview outlining how data gets from the athlete to an electronic device, a database account and other users with whom they want to share the data with.

FIG. 8 schematically illustrates an example application of the invention using a wearable receiver/transceiver to store data and then upload data later to an internet connected device.

FIG. 9a is, in perspective view, a load cell embodiment of the performance monitoring system.

FIG. 9b is the view of FIG. 9a, rotated to show the blade holder cavity with the load cell plate removed to expose the circuit board in the toe cavity and the battery in the heel cavity.

FIGS. 10A, 10B and 10C are plan, end and side views of a generic load cell platform prior to further machining thereof to form a customized load cell platform like that of FIG. 4, whereby the platform fits a particular model and/or size of skate.

FIG. 11 illustrates a pair of customized load cell platforms having been tailored for mounting at forefoot and heel areas of a particular skate.

FIG. 12 is a schematic illustration of a second embodiment performance measurement system installed on a ski plank.

FIG. 13 is a schematic illustration of a third embodiment performance measurement system installed on a snowboard deck.

FIG. 14 is an exploded view illustrating mounting details of the third and fourth embodiment performance measurement systems.

FIG. 15 is a force-time graph generated and displayed by a software application of the system using processed data generated using measurement signals from the load cells in an ice skate embodiment.

FIGS. 16a and 16b show another type of output graph from the software that plots a percentage distribution of force between the heel and forefoot of the skate, the two figures showing such a graph for two different hockey players.

FIGS. 17 and 18 shows a schematic of the second embodiment which is a one-piece configuration that lowers the overall height of the load cell and can be added onto ice skates.

FIG. 19 is a photographic image of a prototype of the second embodiment on a pair of ice hockey skates.

FIG. 20 is the high level architecture of the system including user software and wireless network communication structures. A skate sensor was described to illustrate the architecture but the same architecture can be used for any other embodiment.

FIG. 21 describes the architecture of the real time data display software when a person uses the sensors and a user monitors the activity. A skate sensor was described to illustrate the architecture but the same architecture can be used for any other embodiment.

FIG. 22 describes the architecture of the user analysis software.

FIG. 23 is an output graph of a player who completed a 100 foot speed test from a standing start. Their highest peak force (PB) for the left (L) and right (R) legs are shown in columns one and two. The average (avg) peak force across all steps for the L and R legs are shown.

FIG. 24 shows that the data from both sensors can be overlayed and synchronized in time on the same display graph. The darker line is the right leg and the lighter line is the left leg.

FIG. 25 is a bar graph representing the energy output or effort of the player by showing the accumulated force at the end of each second.

FIG. 26 shows the intensity of a session by describing the percentage of steps that were easy, moderate (MOD), hard and very hard (VH) based on force and step time thresholds set in the software.

FIG. 27 is a histogram of the forces exerted by the player which represents the volume and intensity of the athlete's data set.

FIG. 28 shows the angles of a skate while a player is skating as fast as they can for 100 feet. External Rotation, side to side tilt and heel to toe tilt are represented by individual lines and shown alongside the vertical force (Fz).

### DETAILED DESCRIPTION

### Structure of Measurement Equipment

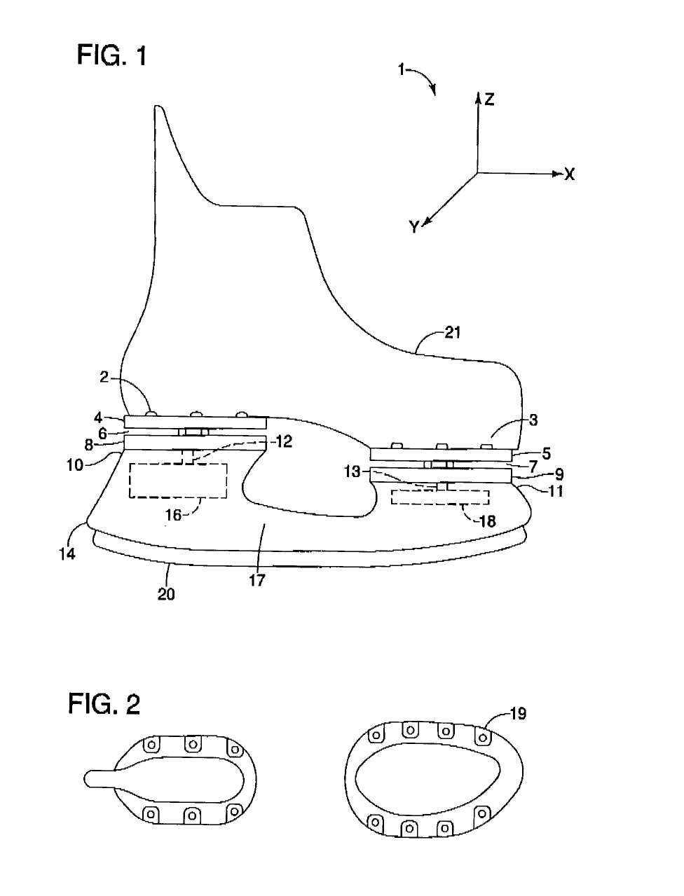

A first embodiment performance measuring system is assembled to a piece of sport equipment, particularly an ice hockey skate, as shown in FIG. 1. The vertical axis of the skate is along the z-axis, the horizontal fore-aft axis is along the x-axis and the horizontal side to side (or medial-lateral) axis is the y-axis (as shown generally at 1).

Load cell platforms (8,9) and adapter plates (4,5) are assembled between the skate boot (21) and the skate blade holder (19) under the heel and under the ball of the foot respectively.

Mechanical fixtures or fasteners (e.g. threaded screws/bolts, or rivets, or a combination thereof) (23) secure the boot (21) of the skate to the adapter plate (4, 5).

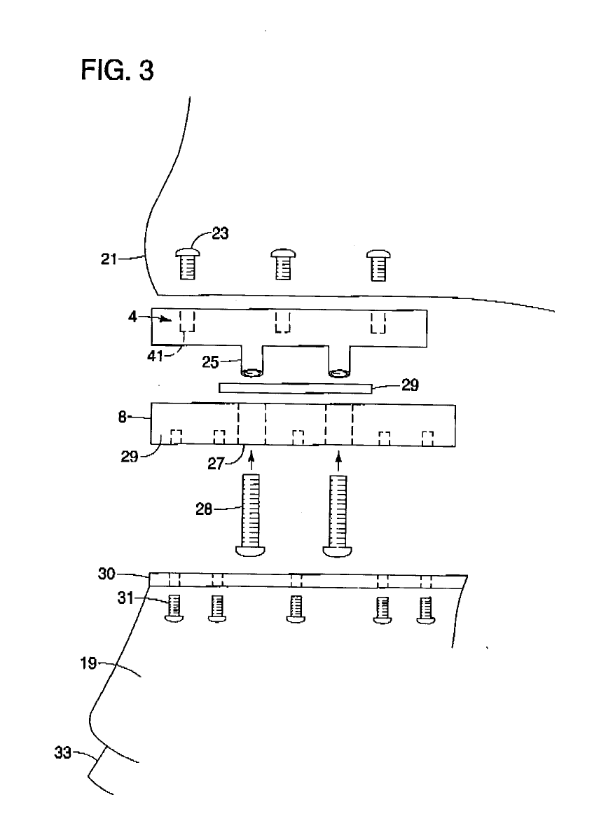

For example, referring to FIG. 3, the illustrated embodiment features threaded fasteners 23 engaged into threaded blind holes 41 in the top of the adapter plate through matching holes in the sole of the skate boot. The adapter plate may be configured with a suitable hole pattern to align with original fastener holes in the boot sole, through which the skate's blade holder was originally fastened to the boot 21, for example by rivets. Alternatively, installation of the boot plate may require drilling of new holes in the boot. The load cell platform 8 is then affixed to the centre of the adapter plate using mechanical fixtures. More specifically, a pair of male protuberances 25 project downward from the underside of the adapter plate 4 into a pair of matching through-holes 27 in the load cell platform 8 for a male/female fit therebeteween. Threaded fasteners 28 are engaged into threaded internal bores of the protuberances 25 through the holes 27 from the underside of the load cell platform 8 to fasten the load cell platform and adapter plate together. A shim or spacer 29 is sandwiched between the fastened-together load cell platform and adapter plate, and the protuberances 25 of the adapter plate accordingly pass through suitably sized openings in spacer 29 to accommodate their receipt in the through-holes 27 of the load cell platform.

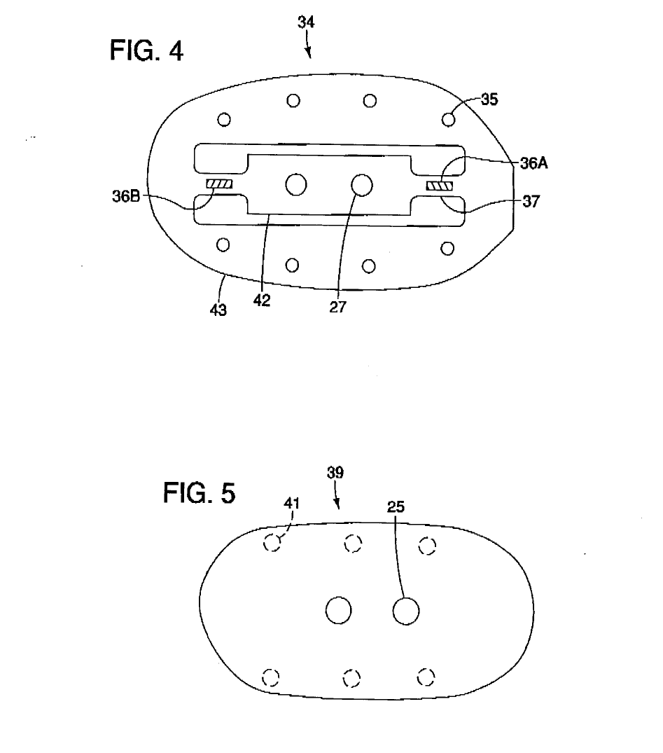

Turning briefly to FIG. 4, the load cell platform is of a substantially flat plate-like form with a closed peripheral or perimeter portion 43 of a ring-like formation extending around a central opening, in which a generally rectangular or bar-shaped central portion 42 resides. Each of two opposing ends of the central portion 42 is integrally joined to the perimeter portion 44 by a respective bridging portion 37 running parallel to the longitudinal fore/aft X-axis of the skate boot. The through-holes 27 for the fasteners 28 that couple of the load cell platform and adapter plate together are located in the central portion 42 of the load cell platform, and the spacer 29 is sized to overlie only the central portion 42 of the load cell 8, and not the surrounding peripheral portion 43. As a result, a small space exists between the topside surfaces of the peripheral portion 43 of the load cell 8 and the adapter plate. This ensures that forces from the boot are only transmitted to the centre 42 of the load cell platform by the way of the attachment between the adapter plate 25 and the load cell platform. The load cell platform is preferably a unitary plate member integrally defining all the aforementioned portions of the platform with seamless connections therebetween, for example machined from a stock body of alloy material.

Turning back to FIG. 3, the bottom of the sport equipment, particularly the blade holder 19 and blade 33 combination in the first embodiment, is then attached to the load cell platform (26). As with the adaptor plate, the blade holder is attached with mechanical fixtures or fasteners (31), such as threaded screws/bolts, or rivets. The fasteners 31 are engaged upward through lateral flanges 30 at the top of the blade holder 19 at suitably sized through-holes therein to feed into the threaded blind holes 29 in the underside of the peripheral portion 43 of the load cell platform.

The pattern or layout of these holes 29 in the load cell platform may be configured to match the original fastener hole layout of the skate boot and blade holder, whereby formation of new holes in the blade holder for fastening of same to the load cell platform is not required. However, other embodiments may require formation of a new hole in the blade holder mounting flange for one, some or all of the fasteners joining the blade holder to the load cell platform.

It will be appreciated that although FIG. 3 shows only the details of the assembly at the heel end of the skate, it will be appreciated that an assembly of generally the same steps and structure is implemented near the toe or forefoot end of the skate beneath the location where the ball of the wearer's foot will reside when the skate is worn.

Turning again to FIG. 4, conventional foil strain gauge sensors 36a, 36b are used to measure changes in material strain to determine forces applied to the load cell platform from the boot of the skate. The bridging portions 37 of the load cell platform are thinner than the central portion 42 of the load cell platform along both the Y-axis and Z-axis, and will deform under exertion of forces on the thicker, more rigid central portion 42 suspended between them along these axes. Downward force along the Z-axis is exerted through the face-to-face contact at the interface of the boot sole with the topside of the adapter plate, the underside of the adapter plate with the topside of the spacer, and the underside of the spacer with the topside of the central portion of the load cell platform. Lateral forces in both directions along the Y axis is transmitted by abutment of the sides of the adapter plate protuberences 25 with the boundary walls of the mating holes 27 of the load cell platform, in which the protuberances 25 are received in a snug-fitting manner. Fore and aft forces in both directions along the X-axis are likewise transmitted by abutment of the sides of the adapter plate protuberences 25 with the boundary walls of the mating holes 27 of the load cell platform.

The foil strain gauges are adhered to the pillar-shaped bridge portions 37 connecting the centre of the load cell platform 42 to the rigid exterior perimeter of the load cell 43. Strain gauges can be adhered in a configuration to measure vertical forces along the z-axis, horizontal forces along the x-axis and y-axis, as well as torque around any of the z-axis, y-axis or x-axis. A wheatstone bridge is then connected to each strain gauge. When the gauge changes shape due to material stress, the voltage coming from the Wheatstone changes proportionally to the shape change. Use of such strain gauges this manner is well known, and thus not described herein in greater detail.

One embodiment of the present invention may omit monitoring of forces in the fore/aft direction, i.e. along the X-axis, thereby reducing the complexity of the structure and operation of the system for use in ice skating applications, where it is the application of forces in the lateral and downward directions that contribute to the strength of the skating stride. Accordingly, such an embodiment may require only sufficient strain gauges to measure strain of the bridge portions 37 along both the Z-axis and Y-axis. Similarly, fore-aft measurement means may be omitted in other edging/gliding sports, such as skiing and snowboarding. Another embodiment may be configured to only take measurements along a single axis, for example measuring only downward force on the Y-axis.

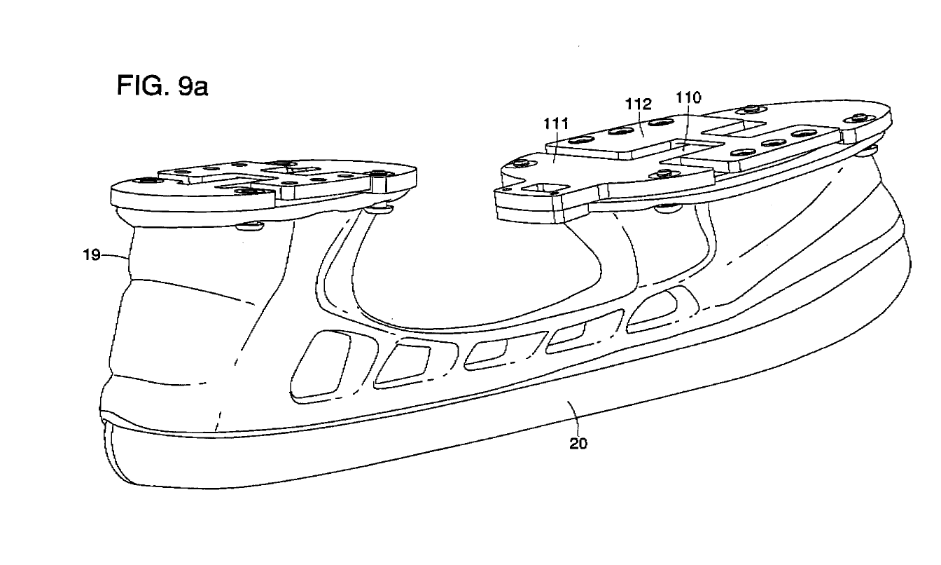

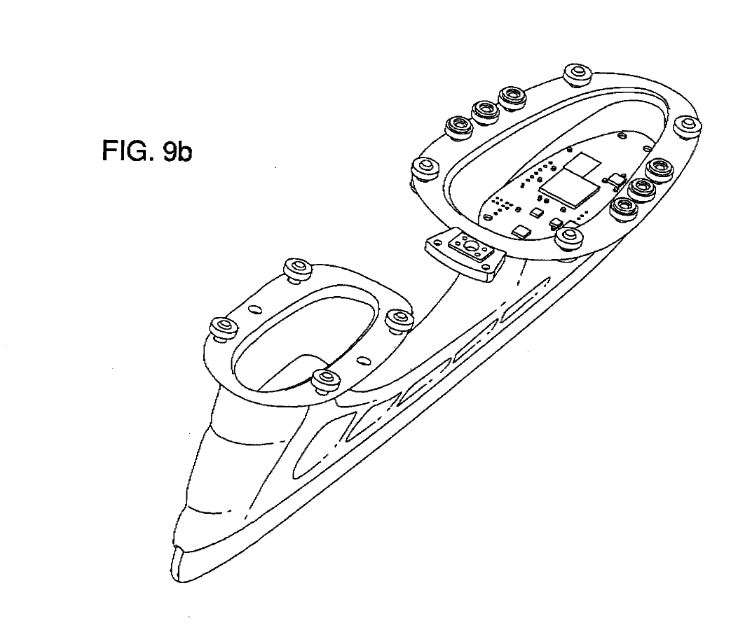

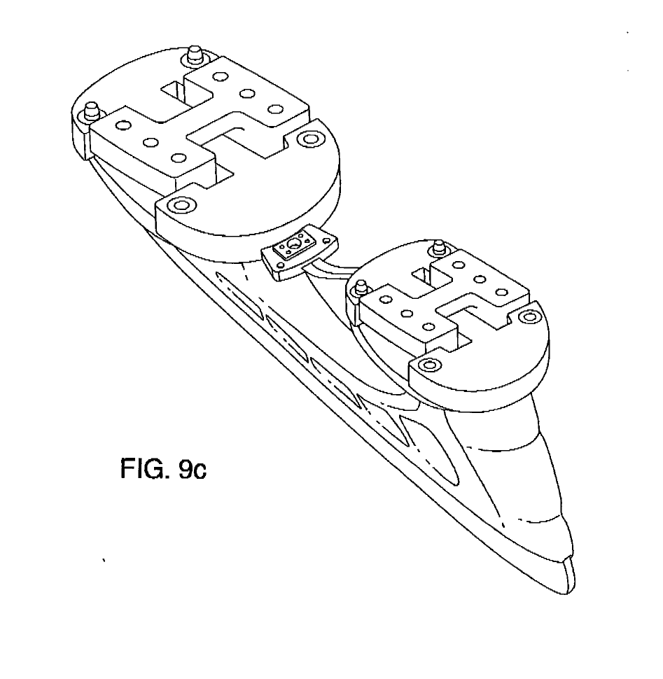

During calibration procedures, a series of weighted loads, for example measured in kilograms, that are representative of forces seen in the field of play are applied to the load cell platform. A coefficient is derived from the linear relationship between the dependent loads placed on the load cell platform and the strains measured using the foil strain gauges. This coefficient thus converts an electrical signal reflective of strain, for example measured in millivolts, to the equivalent in kilograms. Since force is equivalent to mass multiplied by acceleration. Force is then attained by multiplying the result determined kilograms by 9.806 m/s². A printed circuit board (16) designed to be of suitable size to fit in or on the sport equipment is wired (12, 13) to the strain gauge sensors (36A, 36B), for example being internally housed within a hollow interior of the blade holder 19, as schematically illustrated at the heel-attached portion thereof in FIG. 1. The circuit board is also wired (17) to a battery (18) powered voltage supply that is also located on or in the sport equipment, for example being internally housed within another hollow interior space of the blade holder 19, as schematically illustrated at the forefoot-attached portion thereof in FIG. 1. The battery may be rechargeable and if so a charging port may be embedded on the sports equipment. Alternatively, the battery may not be rechargeable in other embodiments, eliminating the need for a charging port. Referring briefly to FIG. 9, the hollow spaces at the forefoot and heel portions of the blade holder are open at the top, which not only enables convenient placement of the battery and circuit board inside the blade holder, but this open space underlying the central area of the heel and forefoot portions of the skate boot also accommodate downward movement of the central portion of the load cell platform under exposure thereof to downward forces during use of the skate.

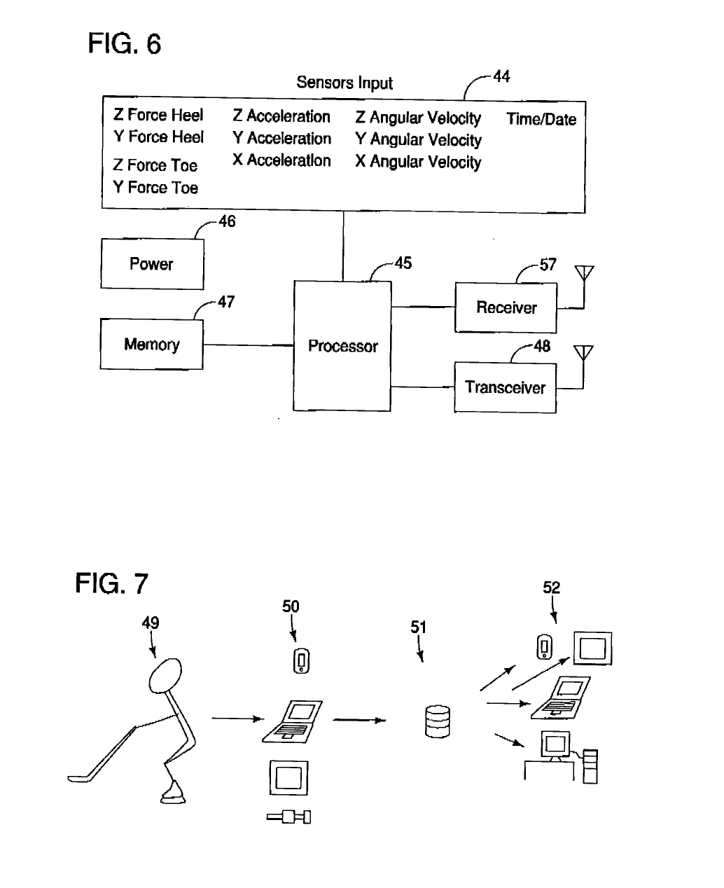

Kinematic sensors measuring acceleration along the x,y,z axes and angular acceleration around each axis may be included on the printed circuit board (16). Turning to FIG. 6, all of the kinetic (load) and kinematic data is sent to a core processor on the printed circuit board. The processor converts analog input from all the sensors to digital values using an ND converter. Each reading from the sampled measurement data is accompanied by a clock reading to tie the particular measurement to the specific point in time at which it occurred. The digital time and measurement values may be saved in temporary storage (47) in computer readable memory on the same circuit board or sent wirelessly via a radio frequency transceiver (48) on the board to user device(s), such as desktop computers, laptop computers, tablets, mobile phones, or other devices with suitable communications means to receive the data from the transceiver. Data is then processed further on the user device and pertinent performance data results are displayed to the user on that device in real-time, or sometime after the data has been collected and processed. In prototypes of the invention, each skate transmits data separately to the recipient computer device, however other embodiments a transmitter in one skate may transmit to a receiver the other, from where the data from both skates is then forwarded on the recipient computer device in the by a transmitter of the second skate.

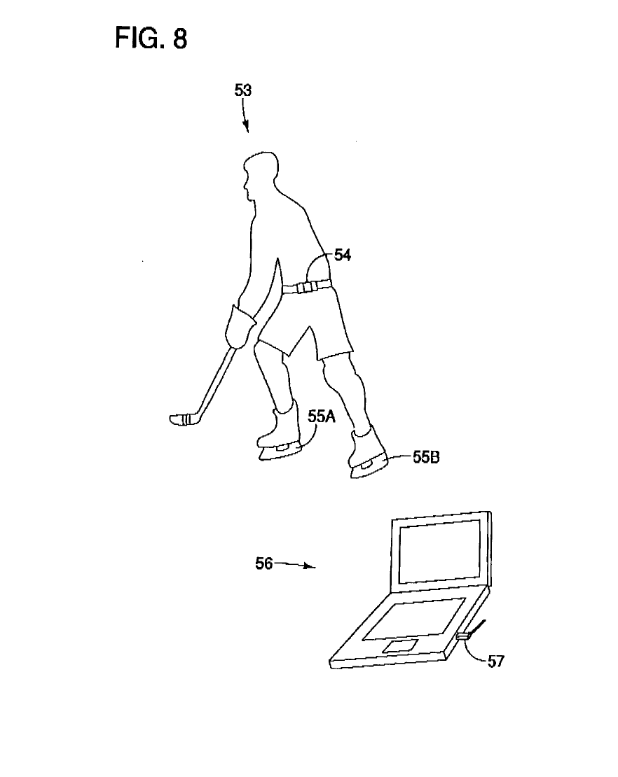

Turning to FIG. 8, data, after being captured on the athlete and wirelessly sent to the user(s) device(s) (49) may be automatically or manually pushed from the user device(s) (50) through an internet connection to a central database (51) where it is stored. The user may re-access the data at any time through software accessible with any type of internet connected device (52). User may also grant other users permission to view the data and perform their own review, analysis and reporting with it. The user may also share the data with friends, family and professionals using email and social channels from within the software.

Turning to FIG. 8, user devices that can receive the data from the circuit board transceiver (48) may also include wearable devices which may be placed on the athletes' body (54). In this scenario, the athlete (53) is able to store data from the sensor transceiver (48) over longer periods if the wearable device has more available memory space that the printed circuit board of the on-skate measurement equipment, and later upload the data to an internet connected device (57) to their user account in the central database (51). The wearable device may also have a data display for the athlete to review live or past results. Additional kinematic sensors may also be placed in the wearable device to measure whole body acceleration, velocity, angular acceleration, angular velocity, position and direction.

The circuit board may also have a receiver to receive data from off-the-shelf sensors such as heart rate sensors, impact sensors, motion sensors etc. or from sensors added to the system in the future. This data is matched in time with the data acquired from the systems sensors. Alternatively, the user worn device (54) may contain such a receiver to capture the off-the-shelf sensor data.

Software applications are being developed to process the data, for example in real-time and to make additional calculations on previously collected data. For each limb the periods of loading and unloading are parsed. Often the period of loading refer to steps, strides, gliding and stopping but could include any type of movement in which the athletes limb is connected to a surface. After parsing the loading phases, many calculations on the unloading and loading periods can be done.

Calculations on the kinetic data from the system sensors under the heel and under the forefoot and for each limb but are not inclusive to are: instantaneous force, average force, peak force, time to peak force, start time of movement, end time of the movement, time between movements, impulse, movement frequency (eg. stride rate), rate of force generation or development (ratio of peak load to the time it takes to hit peak load from zero load). For each of those calculations, a total amount for the entire foot is simply done by adding the calculated value for the heel to the calculated value for the toe.

Certain calculations such as step time and stride rate can be calculated using the acceleration and angular acceleration data. In addition to those calculations, acceleration and angular acceleration data may be integrated to estimate velocity and angular velocity respectively. Linear displacement and angular displacement can be calculated through double integration and optimized using a number of analog or digital numerical methods such as Kalman and Complementary filters.

Since force is measured under the forefoot and under the heel, it is possible to measure the distribution of force in percentage between the forefoot and heel throughout the movement loading cycle. Many other relationships to the aforementioned calculations can be explored such as when peak force occurs on the heel with respect to peak force occurring on the toe.

In summary of the first embodiment, a force measurement system has been designed for ice hockey skates. A force measurement structure is assembled into the skate by attaching the boot to the top of it and attaching the skate holder beneath it, whereby the force measurement system is sandwiched between the boot and skate holder. Strain gauges within the force measurement structure measure material strain when force is applied by the skater. Force is derived from the stress measurements using correlation calibrations. The raw strain measurement data is relayed wirelessly to a communication hub attached to a computer. Results are stored on the computer. The raw data is converted into force and processed in the computer to calculate many measures of performance. Such as instantaneous force, peak force, average force, step time, time between steps and so on. Additional sensors may include an accelerometer, gyroscrope and magnetometer to derive skate movement data such as linear acceleration, angular acceleration, linear velocity and angular velocity. The force and motion data can then be used to evaluate skating performance and to measure improvements. This force measurement system can be used on the ice to provide quick feedback aimed at accelerating skill acquisition, skill improvement, conditioning and rehab. As a result this product has value for players, coaches, teams, medical staff, skate equipment manufacturers and researchers. The final product will store data on the skate and transmit to user devices such as a wristwatch, smartphone, tablet or laptop for display. Data will upload to a cloud based server and be accessible for further data processing, player comparisons and long term tracking.

The present system calculates force and other acceleration based variables used to analyze performance in edging sports. Applicant is presently aware of cycling force measurement systems (such as power meters made by SRM, Quarq, Cyclops etc.) that are commercially available. Force measuring systems have also been made for paddles.

Previous methods of Force Measurement (Stidwell, McGill) glued gauges to plastic. It is commonly known this is acceptable for testing and research (months) but gauge installation on plastic is not sustainable over a consumer product's lifespan. Other methods required heavy parts to the skate and did not allow for circuit boards to be built in to a skate. A force measurement system for sports must withstand water, condensation, wide fluctuations in temperature and large impacts.

In the present system, sensor material is chosen that allows the strain gauge installation to last for the product's lifespan. Sensor location is and geometry conforms to off-the-shelf skates, yet still provides accurate strain measurement, while not significantly inhibiting performance of skaters. The system accommodates wireless data transmission and provides a user interface (buttons for on/off and data transfer modes). It is designed to withstand significant wear and tear, including high impact forces. A waterproof connector provides battery charging and data transfer. The circuit board is waterproofed.

The system calculates power in edging sports. Power is a direct function of both force and velocity. The system measures force in a boot or boot binding (collectively referred to herein as a boot). Velocity may be calculated or inferred using methods using measured or calculated acceleration and stride rate. Power is calculated by indirectly by calculating velocity based on acceleration and/or stride rate.

Velocity may be measured directly using RTLS, RFID, timing systems or video methods. To measure power to date has been elusive due to the difficulty of measuring force in edging sports equipment. The present system combines velocity measurements with force values to calculate power of an athlete.

Explosiveness combines force measures with force application times. Athletes need to create a high amount of force to excel. But more importantly, they need to be explosive, that is, they need to produce high amounts of force very quickly. Explosiveness, is the rate of force development (ROFD), that is how fast force rises (delta Force/delta Time). As used herein, explosiveness means peak force/(step time×body weight).

Body weight may be removed from an absolute measure of explosiveness as used herein. Peak Force can be measured over a single or a fixed multiple of steps (three steps has been found to be a useful measure of explosiveness in hockey), or over a fixed time period.

The statistics and dynamics of an athlete's force, motion, etc. includes the measurement of force magnitudes, and force rate of change, as well as direction vectors.

The sensor in one embodiment allows measurement of torque around the longitudinal axis of the skate (a centre line running from the toe to the heel). The polarity of the torque tells us its direction (either clockwise or counter clockwise). Thus the polarity tells us whether the skater is on their side or outside edge.

Roll, pitch and yaw are also determined using motion sensors (eg, accelerometers). The roll angle also tells us if the player is on their inside or outside edge.

Independently, or, in conjunction with the inside/outside edge determination we know the force, and direction of force relative to the athlete, ie. the force vector, and thus the force vector components along the longitudinal axis of the boot or in the direction of motion. This is done by determining knowing the percentage of force on the heel location relative to the toe location on the boot. It may also include measurements of the boot's pitch.

The system may, in one embodiment, be used to determine the exact and general location of the force vectors. Applicant has determined that depicting the force vector in a zone (eg. the inside edge of the front quarter of a skate blade) is a lot easier for coaches to use when coaching players as compared to the exact force locations.

For example, the blade could be split into four zones along the longitudinal axis of the skate. Each zone has an inside edge and an outside edge. Therefore the player will exert force in one of eight locations.

Knowing the angle of the skate has many advantages in order to improve performance. However distinct patterns were noted in the angles over time. These patterns are cyclic if the movement is repeated. When new movements are introduced, a new pattern emerges. These patterns allow the system or user to identify every time a specific movement occurs. Thus we know the times between movements and the frequency of the movement. An example movement is a stride. Another is a stop. Workload monitoring involves monitoring the frequency (number of sessions per week), the volume (amount of skating in a session) and the intensity (how hard the session was on average).

Counting movements gives the volume of skating over time. The type and how frequent a movement occurs over time gives the intensity.

Intensity measures can also be improved by simply knowing the angular value at a specific point of the movement. For example, in a striding movement, a greater roll angle will mean the player is using more extension in their stride. That stride will be more intense than a shorter stride, for the same step time.

Further improvement occurs by taking into consideration whether this was a gliding stride or a starting step (without glide). A quick (intense) step, without glide, will have higher angular velocities around all 3 axis. A less intense step, without glide, will have slower angular velocities. An intense gliding step will have faster angular velocities than a less intense gliding step. An intensity value can be applied to this continuum of work.

Further improvement is done by taking into consideration both feet. The type of movement and thus its intensity can be depicted based on the relationship between the two feet. In striding forward, one foot is in contact with the surface while the other foot is elevated out with the exception of turns may by a player striding and also simultaneously crossing-over the player's feet of contact with the surface, turning typically involves both feet in contact and going through similar angular patterns but with different amplitudes.

Impulse is the area under the force curve, that; force multiplied by the change in time.

The impulse-momentum relationship allows determination of final velocity of the centre of mass.

Impulse may be thus calculated based on sampling rate (ie. time). The sum of the sample times is the change in time. The force is measured for that change in time. Various numerical methods can be used to make or improve that impulse measurement (eg. Riemann sum), as would be known to one skilled in the art.

The present system uses impulse methods for edging sports. In most foot related movements there is an absorption of force followed by force production.

Knowing the forces throughout the movement does allow one to measure performance. The greater the net impulse (propulsive—absorption) in the direction of travel, the greater the performance (explosiveness, acceleration, speed).

All impulses therefore can be used to measure workload (volume and intensity).

Speed and acceleration measures may be improved by estimating various resistive forces such as friction and wind resistance.

Embodiments of the system may be used to measure the impact of concussions on athletes. Body sway during gait, standing and other movements (balance drills) varies based on the concussion grade. The system allows the grade of concussion to be measured or estimated in sports equipment the player actually trains and competes in.

The system measures sway by measuring the fore-aft balance on one foot and fore-aft balance on two feet, side to side balance on one foot and side to side balance on two feet. The system may thus provide real time monitoring of a player before, during and after an impact. Trend analysis may also be used to flag players who have suffered injury, including concussions. That is, the same approach which may be used for concussion analysis may also be used for other injury that will impact the player's performance (eg. groin injury, pulled muscle, contusion, rib injury, etc.). In a sense, this provides a sport physical on the athlete while the athlete competes, trains or rests.

However, an athlete does not have to be injured in order to have deficiencies in performance. Also, deficiencies may put the athlete at risk for injury.

Embodiments of the system may using the sensor data, distinguish asymmetrical differences between left and right legs by comparing force levels, step times, etc. Such differences may lead to injury.

Users may set thresholds for comparative differences between right and left legs to flag pending injuries.

By measuring an athlete's step by step performance, a user is provided with methods for determining, as well as distinguishing between, neuromuscular and metabolic fatigue.

In competition and in training or practice, athletes may be monitored for neuromuscular and metabolic fatigue. This allows coaches to manage their athletes in competition and while out of competition. Trend and relationship analyses compare performance variables the coach thinks may impact performance against measures of neuromuscular or metabolic performance. The present system allows users to determine the type and level of fatigue occurring in order to optimize competition and training performance.

Applicant has determined that in edging sports like hockey, important information may be obtained by measuring an athlete's performance of the athlete's first three strides or steps. Timing systems have inherent errors that make it difficult to compare one step or even the first three steps amongst a group of athletes.

Further timing by itself provides incomplete data. Determining for example intensity (eg. measured) in addition to timing provides a better performance indicator.

Using the present system, velocity may be determined by measuring acceleration. From acceleration, the system can calculate velocity.

This provides the athlete's instantaneous velocity. From this the system may also derive distance the athlete travels.

Improvements can be made by taking into account resistant forces (ice friction, air resistance), augmenting the acceleration determination with accelerometer data (g forces), using a sensor to detect changes in direction (magnetometer for example), and calculating the angle of force application so that the force vector and therefore the horizontal velocity may be determined.

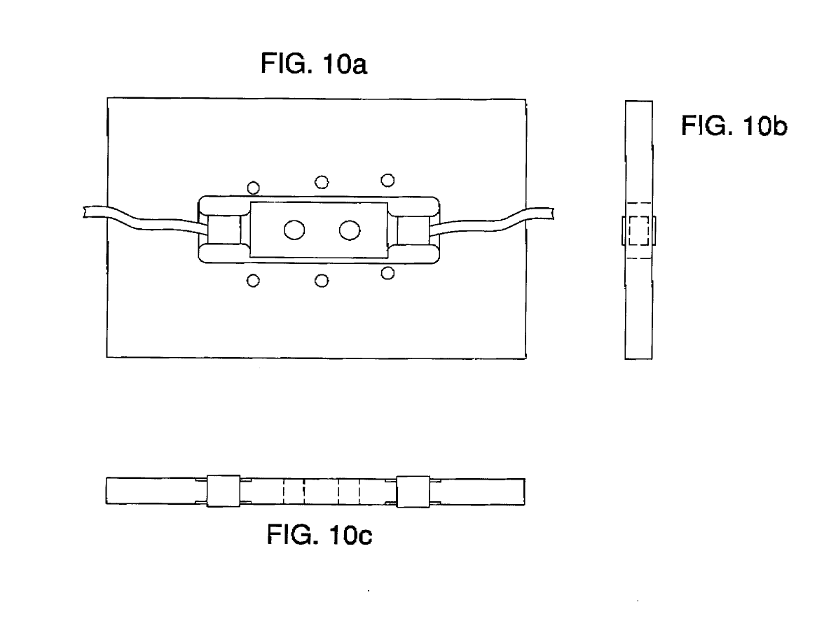

Turning to FIG. 10, illustration of the load cell platform during an intermediate stage of manufacture of illustrated. This unfinished load cell platform has a rectangular outer periphery which is later machined down to an appropriate size and shape to generally follow the perimeter size and shape of the heel or forefoot area of a particular model and size of skate, thus providing a fully customized final product that minimizes or avoids any increase to the footprint size of the skate to which the load cell platform is to be applied. Part of the customization may also include custom drilling of the fastener holes for attaching the load cell platform to the blade holder so that the hole pattern aligns with that of the existing original fastener holes in the mounting flanges of the blade holder. Preparing the final product from an intermediate standard unit may save on fabrication costs, as the standard unit can be produced in significant number to reduce the overall cost of manufacture by standardizing the initial fabrication steps among all, or at least several, model and sizes ranges of skate. That is, all or many skate models and sizes may be able to employ load cell platforms that are customized from an intermediate product of a standardized outer perimeter size and shape, and standardized size and shape of cutout forming the central portion 42 and surrounding opening and bridge portions 37.

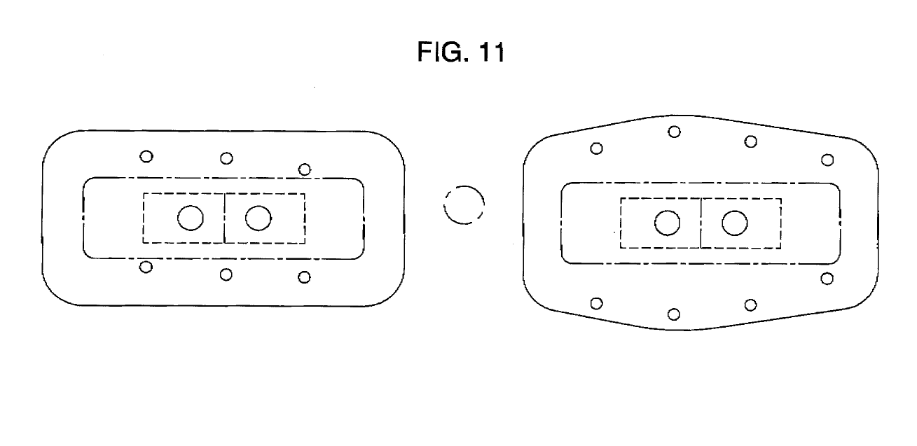

FIG. 11 illustrates a pair of load cell platforms for one skate which may both be produced from a standard intermediate product before final customization of same to create the appropriate outer perimeter shape and fastener-hole pattern for the heel and forefoot areas of the particular skate in question.

While the adapter plates and load cell plates of the illustrated embodiment are illustrated as having flat, parallel top and bottom surfaces for ease of illustration, it will be appreciated that the topside of the adapter plate may need to be a non-planar profiled surface in order to mate in flush contact with the underside of the skate boot, depending on the shape thereof, and likewise the underside of the outer peripheral portion of the load cell plate may require a non-planar surface profile to mount flush with the topside of the blade holder mounting flanges. Contouring of the adapter plate and/or load cell may be part of the customization process required to ensure compatibility of the product with a particular skate model or size.

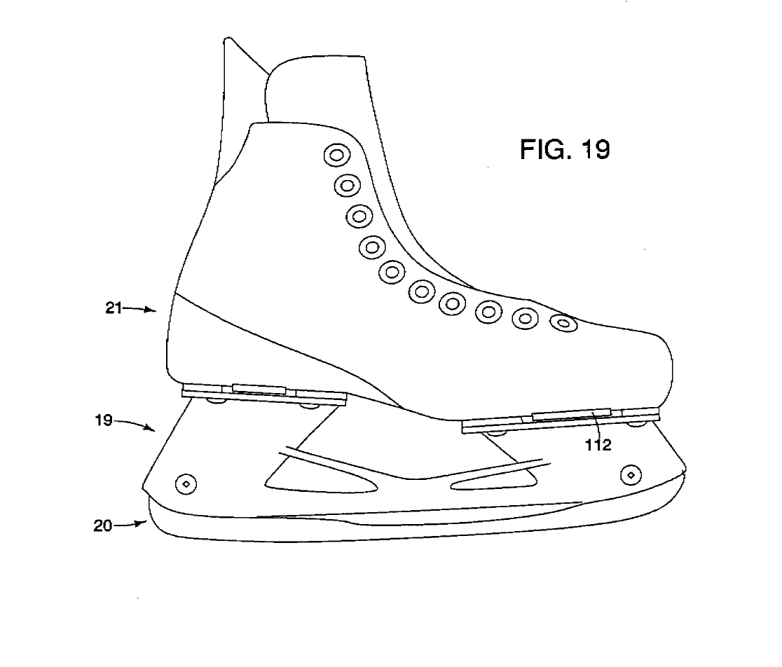

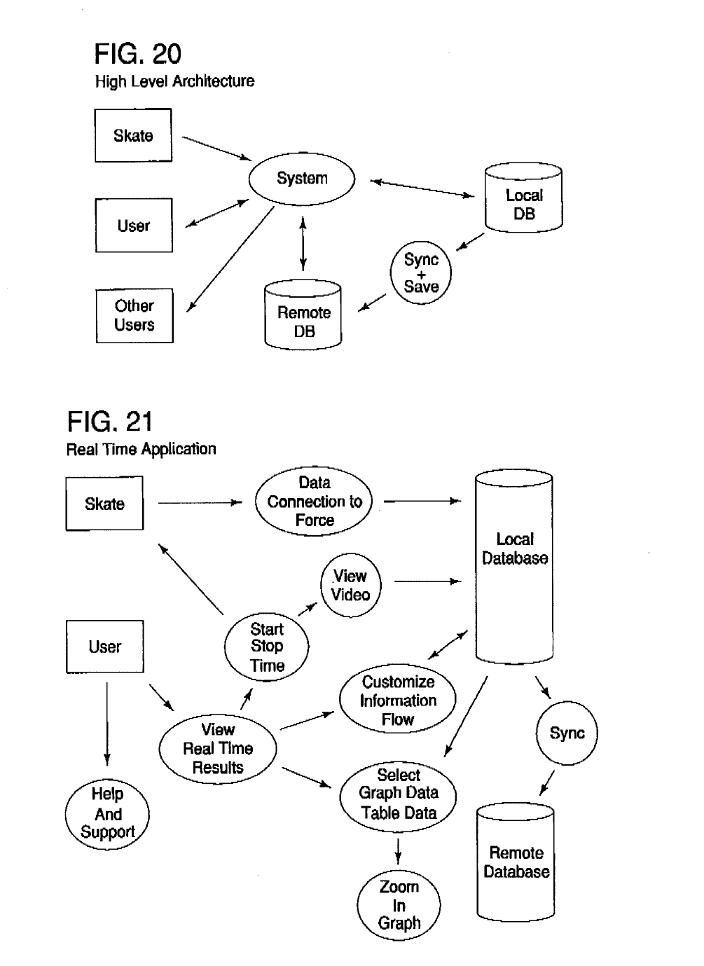

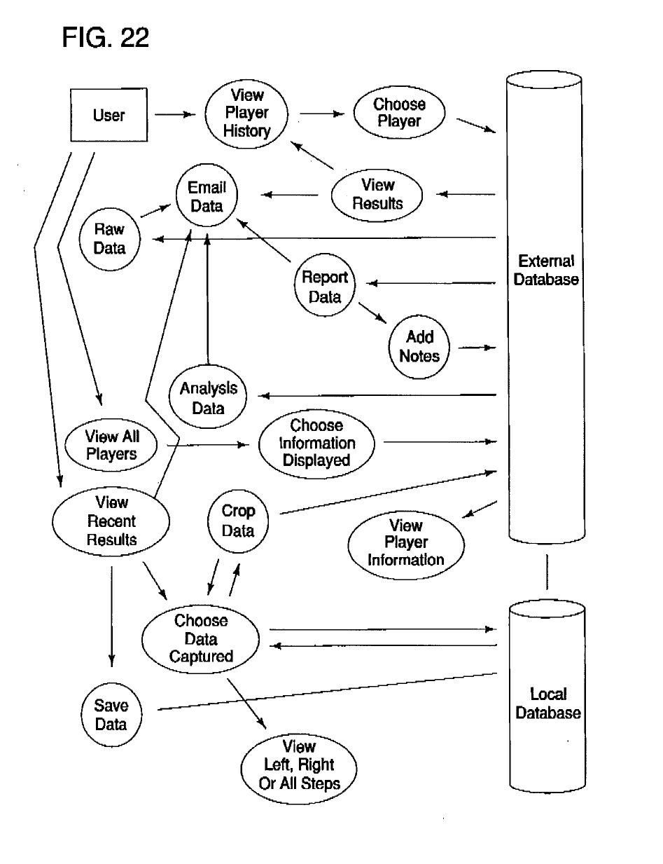

FIGS. 9a, 9c, 17, 18, 19 show an embodiment of the invention where the top and bottom plate have been combined and built as a one piece system wherein the top plate and bottom plate are fused together. Such design allows another option for manufacturing and potentially more applications in sporting goods equipment.

The outer periphery of the top and bottom plates can be altered. It need not be a solid periphery depending on the sport equipment surfaces it is attached onto. For ice hockey skates such customization has included removing the middle portion of the outer periphery since the top of the blade holder provides sufficient rigidity to maintain the integrity of the load cell sensing system. This customization greatly lowered the overall weight of the system thus being more appealing to skaters. It has also included shrinking the top plate so that its surface area sits within the gap now created by removing the middle portion of the outer periphery.

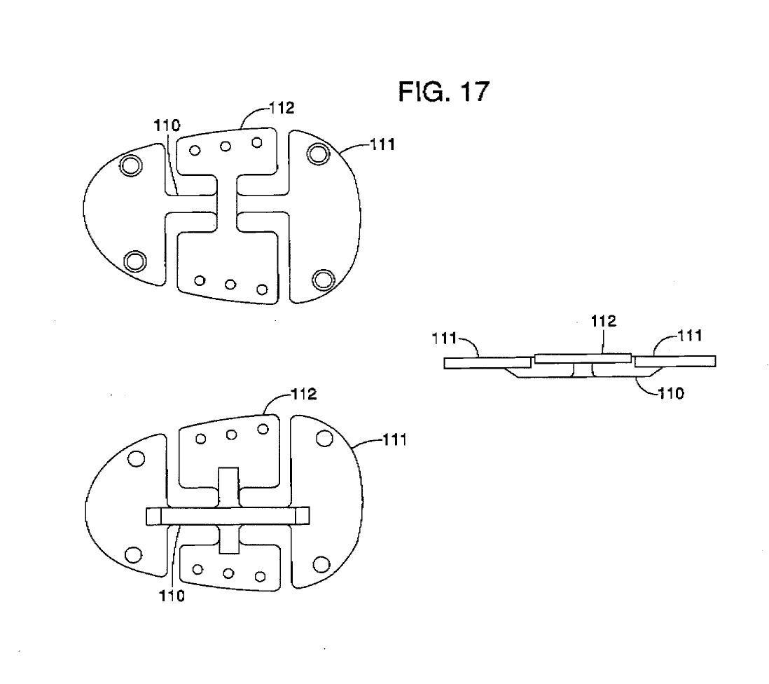

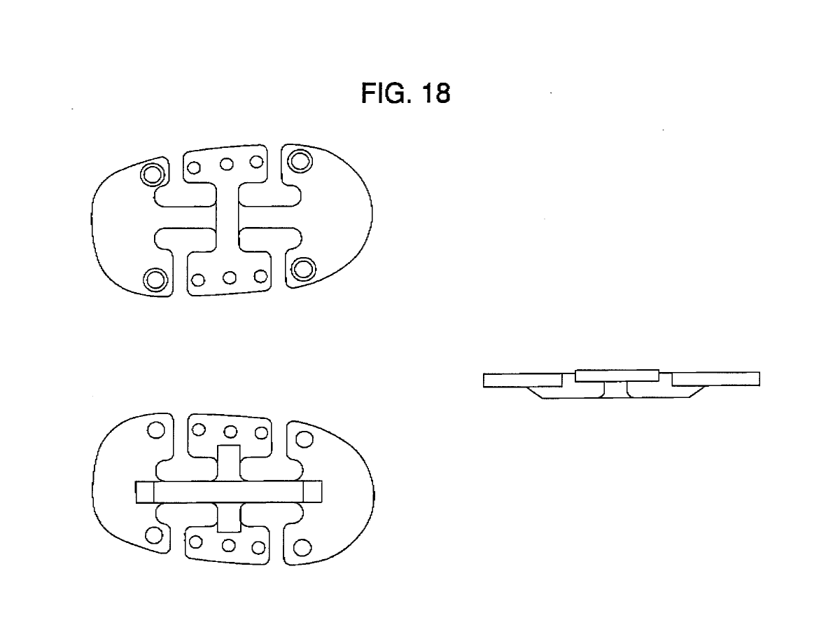

As shown in FIGS. 17 and 18, the load sensing columns in the centre of the load cell 110 can also be lowered below the level of the bottom plate 111. This means the sensor columns nest lower in the cavity of the skate holder yet still allow enough room for the electronics to be housed in the cavity. The height and weight of the load cell is lowered by removing the middle portions of the outer periphery of the bottom plate 111, shrinking the surface area of the top plate 112 and lowering the sensing columns 110. Meanwhile performance of the load cell is retained.

Although the forgoing description is presented in the context of a hockey or other ice skating application, similar assembly can be done on other types of edging or near-edging sport equipment (eg. Skis for snow or water, snowboards, skateboards, in-line skates) (ie. with wheels) by adjusting the bolt patterns and geometry of the load cell platform, and the adapter plate bolt patterns and geometry.

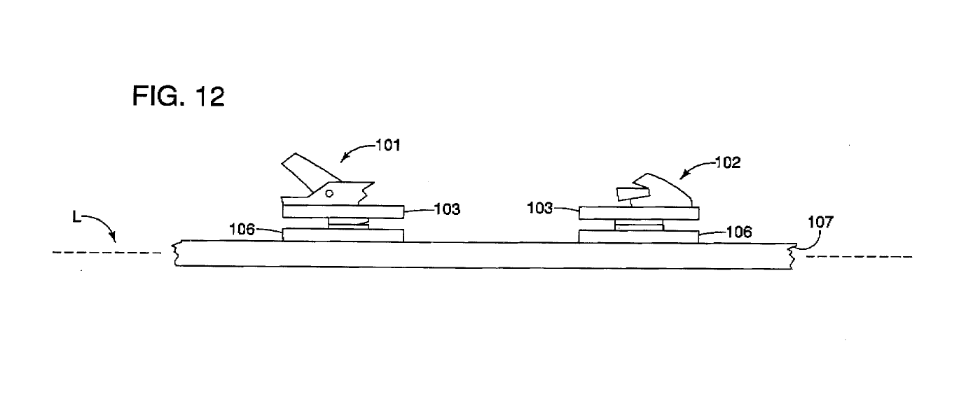

FIG. 12 illustrates a third embodiment in which two load cell platforms are used for each foot to provide both heel-area and forefoot-area measurement apparatuses, but for a ski application rather than an ice skate application.

The ski plank 107 normally has a binding mechanism mounted directly thereon for each foot. The mechanism features a heel binding 101 at one position along the longitudinal axis L of the ski plank 107, and a toe binding 102 at a second position spaced along the ski plank 107 from the heel binding. To install a performance monitoring system of the present invention, the binding mechanism is removed from its normal position on the ski plank, just as the boot of the ice skate embodiment was removed from the blade holder to prepare for installation of the performance monitoring system. In the ski embodiment, the adapter plate 103 of each measurement apparatus is mounted to the underside of the respective one of the toe binding and heel binding in place of the ski plank, and the respective load cell platform 106 is in turn mounted to the underside of the adapter plate with a suitable shim or spacer between the two. The load cell platform 106 is mounted atop the ski plank 107 in place of where the respective binding was originally mounted, thereby completing the assembly in which the mounting plate, spacer and load cell are sandwiched between the binding and the ski plank. With this complete for both the toe binding and the heel binding, the two measurement apparatuses are thus installed, and will operate in a manner similar to the ice skate embodiment, as in use of the ski, forces from the wearer's ski boot will be transferred to the load cells via the clamping of the ski boot to the measurement apparatuses by the binding mechanism disposed thereatop. Accordingly, the adapter plate and load cell platform operate in the same manner as described for the ice skate embodiment in order to detect strain and use the resulting signals to provide output concerning forces being applied from the boot. The invention may be applied to any of various different types, styles or shapes of ski, including the ‘planks’ of conventional long narrow skis or blade or board of shorter ‘ski blades’ or ‘ski boards’, also sometimes referred to as ‘snow blades’.

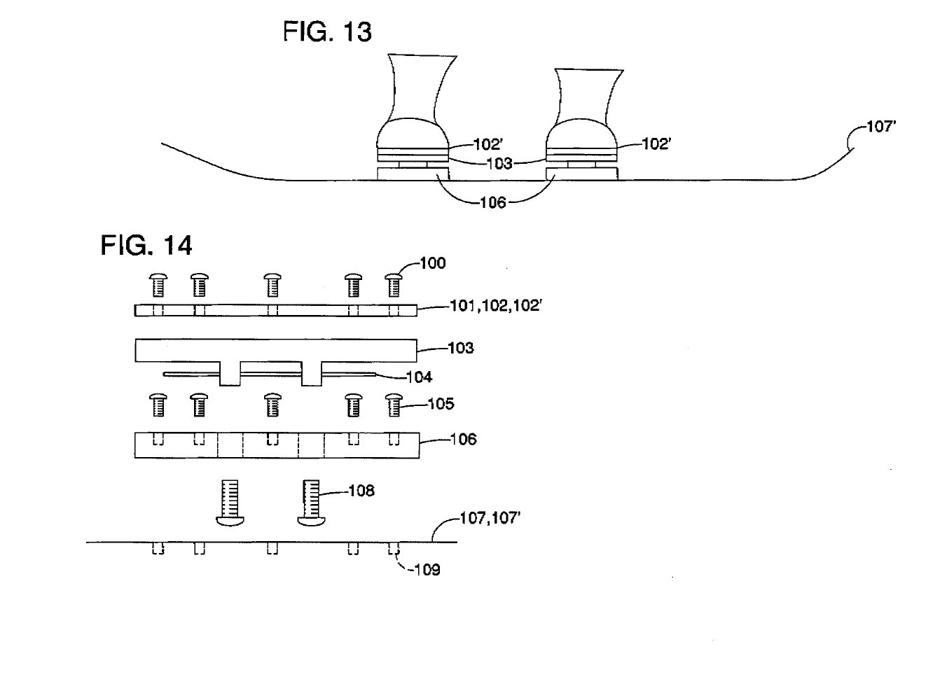

FIG. 13 illustrates a fourth embodiment snowboard application of similar structure to the ski application of FIG. 12. Two load cell platforms are again installed between the binding mechanism for each foot, one at a heel area thereof and one at a forefoot area spaced therefrom. With additional reference to the assembly view of FIG. 14, which demonstrates the assembly process for the ski and snowboard embodiments, the binding mechanism 101/102 is removed from the snowboard deck or ski plank, and each adapter plate 103 is attached to the underside thereof by suitable fasteners 100. As for the ice skate embodiment, it may be possible to employ existing fastener holes for attachment of the adapter plate. The load cell 106 is attached to the adapter plate 103, with the spacer 104 therebetween, by fasteners 108. The load cell 106 is attached to the snowboard deck or ski plank by additional fasteners 105 engaged into threaded blind holes or recesses 109 in the topside of the snowboard deck or ski plank via through-holes in the perimeter portion of the load cell. The heads of the fasteners holding the load cell to the snowboard deck or ski plank may be countersunk to avoid contact of the fastener heads with the adapter plate spaced shortly above the perimeter of the load cell.

A fifth embodiment involves placing the load cell 106 in training and fitness equipment for edging sports. Slideboards are often used by skaters to simulate skating off the ice. They push off from one side, slide to the other side and then push back. The load cells 106 are attached to each side so that the push force can be measured.

A sixth embodiment involves placing the load cell in the bottom of a boot that then slides on the slideboard. As with the skate, the load cell is affixed mechanically to the bottom of the boot. Below the load cell is the sole of the boot. This sole has a frictionless material on it that slides easily on the slideboard. The low profile of the load cell makes this design feasible versus using conventional load cells.

Where the ice skate embodiment takes advantage of open space at the top of the blade holder to accommodate downward movement of the center portion of the load cell under vertical loading thereof, such space may not be readily available in the ski and snowboard embodiments. Accordingly, one embodiment of the load cell may have a greater thickness at the outer portion 43 of the load cell than at the inner or central portion 42 thereof, whereby the bottom surface of the outer portion is disposed at lower elevation than the bottom surface of the central portion when the cell is in its natural unloaded state. The resulting space between these surfaces overlies the ski plank is provides room to accommodate downward movement of the central portion.

### Use of Measured Data

### Software

User software refers to software that specifically runs on the users viewing device.

Such a device could include mobile or desktop devices. As seen in FIG. 29a, a Web App is what we are referring to as the user software with the current design. A system block diagram is seen in FIG. 29b.

PROCESS DIAGRAMS ARE INCLUDED SHOWING: Skate Sensor Transmission and Reception (see FIG. 30), Sensor Receiver (see FIG. 31), Skate Sensor Data Transmission Software Process (see FIG. 32), Data Acquisition (see FIG. 33) and User Application Software Process (see FIG. 34).

Data collection can be done with any type of device including (but not exclusive to) custom made data collection boxes, smartphones, tablets and personal computers.

### Data Processing Overview

Events include specific steps, stops, turns and pivots. Trials are periods of time highlighted by the user for analysis. The trial data is then parsed into individual events either by the user or automatically by an computer analysis script. For example, the start and end of step 1 on the left foot is identified and the start and end of step 2 are identified and so on. Or, in a skiing example, turn one on both ski's, turn two on both skis and so on. Once the trial is parsed into specific events, numerical, as well as, statistical methods are used to calculate meaningful measures of performance for athletes, parents and coaches.

### Process Flow Diagrams

In the load cell embodiment, sensor determination of force is as follows: Player exerts force on skate; Load cell is compressed; Compression causes bending strain; Strain sensors change resistance in proportion to strain.

Digital clock records when the resistance measurement is taken. Change in resistance is measured and converted to digital units in A/D converter. Known offset (baseline) is subtracted off of the digital units. Known calibration coefficient converts digital units into units of force. Level of force is now known and can be expressed over time known based on each strain gauge measurement.

### Offset Determination

In order to properly calculate force with the skate sensor load cell, an offset must be determined. It simply involves recording the sensor outputs when zero load is placed on the skate and the skate is held in a vertical position on the ground.

### Calibration Coefficient Determination

Three methods have been used to determine the calibration coefficient:

1. Applying multiple forces and multiple torques that are known. For example, place 50 kg on top of the skate.
2. Using a servohydraulic actuator to exert known force and displacements on the load cell (ex. INSTRON 8872).
3. Putting various loads on the skate while measuring force using a force platform (ex. KISTLER Force platform).

In each of these methods, increasing loads are incrementally placed on the skate. The skate sensor reading is recorded for each load. Then a linear or polynomial regression is applied to the set of data to find the calibration coefficient(s). This is done for each load cell. It can be done with the load cells applied to a custom fixture for ease of use or to improve validity, it can also be done with load cells installed on the skates.

### Trial Analysis

The following describes how the process of how trial data is parsed into steps by the user or by using a computer algorithm to do it.

### User Controlled Trial Analysis

Database stores data. User interface sends command to retrieve specific set of data User inputs start point of analysis and end point of analysis. User labels this new analysis set (player name, start/stop, forward, backward, pivot, game, practice).

User selects start and end point of each event. Program runs numerical methods on each event. Descriptive Statistics (average, stdev, max, min etc.) are calculated on the set of events.

### Algorithm Driven Trial Analysis

In this process, the analysis software automatically identifies the type of event that occurs and/or automatically parses each specific event. Again, the database stores data. User interface sends command to retrieve specific set of data. User selects type of analysis they want to do. Program parses the events based on the analysis selected. Program runs numerical methods on each event. Descriptive Statistics (average, stdev, max, min etc.) are calculated on the set of events.

### Descriptive Statistics

Descriptive statistics (average, maximum, minimum etc.) and an example measure of interest specific to hockey may include:

1. Within an event (maximum force).
2. Across any number of events (best maximum force score).
3. Within a trial (best maximum force score within a whole trial).
4. Across multiple trials (improvement of maximum score over time).
5. Within an individual (best-ever maximum scores for the individual).
6. Across individuals (average maximum score for a team).

### Angular Measure Determination

### Accelerometer and Gyroscope Conversion

Accelerometer and Gyroscope (also referred to as “sensors” herein) Sense Changes in Movement. A/D converter and clock sample sensors and convert to digital values. Digital values are converted to normal acceleration units (m/sec²) and normal angular velocity units (degrees/sec) with known conversion factors. Offsets are determined by aligning the skate along each axis (x,y,z) and in the reverse direction of the axis. Average is then taken for each axis to come up with the final offset for that axis. The offset is then subtracted from the digital values measured during the movement to attain a zeroed measurement. This results in acceleration values (m/s²) and angular velocity values (m/s).

### Sensor Data Fusion to Determine Angular Displacement

The accelerometer accelerations and the gyroscope angular velocity measurements are combined in a complementary filter to attain angular displacement values for each data sample. Kalmann filters can be used to improve the quality of the angle data.

This results in pitch, yaw, roll measures of the sensor throughout the movement.

Each movement has a distinct angular pattern to it (ex. Skating stride versus a skating stop).

Depending on the sport and level of the athlete coaches will expect and try to achieve a desirable movement pattern. For example, in hockey leg extension is very important. The more the leg extends the greater the roll of the skate will be.

Stride rate can be calculated by identifying the maximum point of roll each stride. This point occurs at the end of each stride. Since we know the time of each sample we can determine the time between the points of maximum roll and thus the stride rate which is the steps per second.

The number of steps (eg. volume of skating) can be measured by counting the number rolls seen as identified by the minimum and maximum points.

The intensity of the movement can be measured by the number of steps or other events (ex. Stops) that occur per second, minute or hour. Improved intensity measurements can be achieved by grading the level of pitch, yaw and roll while taking into consideration the stride rate. That is, the greater the pitch, yaw and roll, as well as increases in stride rate yield a higher intensity outcome.

### Numerical Techniques Used

### Step Parsing

In stepping movements, the start and end of the step are determined when the load value exceeds the zero and noise baseline. Depending on the noise typically seen in the signal (ie. load), a correction factor can be applied to best estimate the true point of impact or point of takeoff. Correction factor improves the measurement since the threshold method will lead to a overestimation of the true point since time passes between the true impact or takeoff and when it is detected above the threshold.

### Angle Determination

Complementary, Kalmann and other filters can be used to determine angles using both the accelerometer and the gyroscope data.

### Load Accumulation

As a measure of movement volume, load is accumulated over the period of interest. As a measure of volume as well as intensity, the amount of load accumulated per unit time is calculated. To eliminate loads when the player is not moving (just standing), the net load (load—load due to body weight) is accumulated in this calculation instead.

### Moving Average

A moving average is calculated to look at the loading patterns over units of time. The higher the average, the higher the harder (more intense) the athlete is moving.

### Propulsive Peak Determination

A numerical filter is used to remove peaks that occur near the beginning of a movement (due to the impact and loading impulses) and thus are not contributing to propulsion. With those peaks removed or ignored, the maximum value is found in the remaining data and is labeled as the peak load.

### Load Distribution

Load distribution is determined by dividing the load of interest by the sum of loads multiplied by 100%. For example, the toe load is divided by the toe and heel load sum and multiplied by 100%.

### Load Distribution for Various Movements

All measures including load distribution can be calculated for stops, turns, pivots and all type of movement that occur in an activity. This provides unique insight into an athlete's movement effectiveness, strength, quickness and explosiveness in any movement.

### Step, Recovery and Stride Times

Since the start and end of each step is known we can calculate the step time (point of takeoff minus the point of impact). Recovery time is determined by subtracting the impact point in time from the takeoff point in time from the previous step. Stride time is the time between two consecutive impact points in time.

### Glide Time

By determining the point where propulsion starts, the glide and propulsive time can be calculated. Glide time is from the point of impact to the point when propulsion starts.

### Propulsion Time

Propulsion time is from the point propulsion starts to the time push-off occurs. The start of propulsion can be determined by: finding the low point that occurs after impact but before propulsion begins that occurred in time prior to the peak propulsive force; and, calculating the net load (load minus the load due to body weight) and then finding the point well after impact when the load rises above zero.

Time to Peak Is the time it takes from impact till the time the peak propulsive load occurs.

### Rate of Force Generation

Is the peak load divided by the total time it takes to reach the peak.

### Impulse

Impulse is calculate using a Riemann sum or using other area under the curve calculation methods.

### Intensity and Training Load as a % of Best Scores

Either in a test or by taking an athlete's best scores for any type of measure, Future training load measures can be represented as a % of that players best score. For example, in a hockey game, a player hits their best ever explosiveness score when they chase after the puck. All explosive scores are represented as a % of their best. This becomes their intensity score. Which is used in this equation of training load:

Training Load=(Intensity×Duration) raised to a constant or multiplied by a coefficient

### Basic Training Load

Training load=(Intensity×Duration) raised to a constant or multiplied by a coefficient.

Intensity can be calculated any numbers of ways as previously described. Peak force, average force, cumulative force per second, propulsive impulse, explosiveness etc.

The weighting factor takes into consideration the impact the intensity and duration have on the body. Neuromuscular and metabolic fatigue will rise as intensity and duration increase and that is represented in the training load measure.

### Movement Effectiveness

In edging sports, effective movement occurs when higher percentages of load is in the desired direction (it is an effective load). By summing up all loads, efficiency can be calculated by:

Movement Efficiency=Effective Load/Sum of All Loads

### Leg Power

P(leg)=Force×Velocity(leg extension velocity)

Leg extension velocity correlates to the angular velocity of the skate, rate of force development and other load measurements. Therefore can be determined mathematically.

Power is a very useful measure in activity as demonstrated by many (different) commercial methods to calculate power.

### Equivalent Speed and Distance

As a measure of volume, data collected in tests can be used to predict speed and distance. Any measure of the load can then be correlated to straight away speed or distance. We know this is not an actual measure because there are many changes in accelerations and changes of direction that are not taken into consideration in this calculation. By adding up all of the loads, one can then correlate and thus calculate an equivalent average speed or total distance if they had maintained the movement in a constant direction.

### Explosiveness

Takes into account the amount of load generated and how fast the movement took. A sport or activity specific weighting factor can be applied to weight either the load or the movement time to represent their respective significance to true explosiveness.

### Statistical Methods

On steps, trials, athletes and populations the following statistics can be done on each calculated measure: Maximum, Minimum, Standard Deviation, Mean, Median, Mode, Histogram, Regression analysis including trendlines.

### Example Training Regime

For Speed Training/Anaerobic Power Training in a: 100 foot test, get 3 step results and final step results; perform repeats at 90-100% of those results (with near real time feedback); track progress over weeks; work on start speed at 95-100% of first three steps (with near real time feedback); work on speed endurance, starting at 90% and working up to 100% (with near real time feedback); work on repeat sprint endurance, 6-10 * 90%, then progress to 95%, never 100%.

For Anaerobic Capacity (30-60 s): high lactate training; can do 30 s benchmark test; then pace future intervals so athletes can maintain as much speed as possible, and stop before being bagged.

For Aerobic Power (VO2): can do common 30 s or 3-4 minute hard efforts to estimate VO2; using select measures from the test, can then train players as a percentage of VO2.

The following description outlines an example of how output from the measurement apparatus on a pair of skates may be used. The example is presented in the context of a 100-foot speed test, administered to hockey players by their coach. As outlined above, the sensor equipped skates measure force under both the forefoot and heel of each skate. Vertical force and lateral side-to-side forces are recorded for each location. Additional motion sensors may also used in the skate to acquire data for future analysis.

In the graph below, a Jr. B player had skated a 100 foot forward speed test using Blur's force measurement system. As may be seen, no outside edge torque (no positive values) is produced for the first set of steps including step 1. Only weight and torque on the inside edge is seen.

By step 4, the player is clearly placing an outer torque on their outside edge before an inside edge torque is produced.

Skate coaches often teach players to bring their skates towards their body midline and to establish weight at some point in the stride on the outside edge, then transfer to the inside edge as they start the push phase. When the outside edge is set and the time spent on the outside edge is also important to optimize the players skating stride.

The force assessment system is thus able to identify if and when a player is putting weight on their outside edge during their stride on the ice. Thus, the coach and player can do edging drills and review data each time to see if they are achieving the results they desire.

Data may be recorded to a computer device (desktop computer, laptop computer, tablet, smart phone, etc.) wirelessly. Skating or hockey coaches can then use analysis software to calculate a large number of metrics on each step, or for a number of consecutive steps, taken by the player in the test. Another embodiment may employ real-time display of the processed data to give coaches and players the ability to make adjustments in technique or conditioning within an ice training session.

The raw data from the digital conversion of the signals received from the strain gauges, and other sensors that may be included in the measurement apparatuses on the skates, can be further processed to provide a number of different usable data types. One such data type is a peak force, for example displayed as a percentage of the player's body weight, which is recorded as input to the software, whether entered as a weight (i.e. a force, e.g. in pounds) or entered as a mass (e.g. in kilograms) and converted into a force using the gravitational acceleration constant. For example, 200% is equivalent to 2× their body weight. It is the highest force recorded during the push-off by adding together the heel and forefoot forces of skate that is being used to push-off from standstill at the start of a test run. Another example is using points in time at which the detected vertical force approaches zero to determine the step time, i.e. the amount of time from when the point the skate hits the ice to the point it leaves the ice for that step. Another example is rate of force development (ROFD), which is the rise in force divided by the change in time that occurred during that rise in force. It may be divided by the players body weight (BW) to take into account the size of differently sized players. The ROFD can be calculated for any change in time. For example, this could be during the push phase within a step or could be across the entire step, any phase of the step for that matter

One can compare key metrics such as step time and peak force during various drills and compare those results to “ideal” technique. One can also measure load distribution between the forefoot and heel which tells the players weight distribution throughout a stride or other movement. One can assess a skater's or player's technique for many types of movements such as push-off steps, first three steps, strides at maximum speed, sharp turns, stops, pivots, backward skating and so on.

A coach can compare tests results of potential young prospects weaker players against the best players on the team to better understand their strengths, weaknesses, risks for injury and potential for improvement. Results from regular benchmark tests will help a coach establish individual and team norms, helping the coach monitor team performance (i.e. endurance, fitness, fatigue, and onset of illness/recovery from illness or injury) through the off-season and in-season. The data will give the coach additional insight to enable better planning of team practices, on-ice training, off-ice training, rehab sessions, and rest periods.

With players in the skates, a coach can provide them with specific guidelines for each conditioning drill, thereby establishing paces for on-ice conditioning, whether it be for acceleration training, speed development, VO2max (a.k.a. maximal oxygen consumption, or maximal aerobic capacity), aerobic endurance, anaerobic power or anaerobic capacity training. This may be analogous for example to using timing gates for sprint training in running or using power meters to train cyclists. An example for anaerobic capacity power training is skating back and forth for 30 seconds and taking 60 seconds rest between each interval. In embodiments of the invention employing a skater-worn device providing real-time data output readable by the skater as well as the coach, the coach can tell the skater to skate at an exact percentage (e.g. 93) of their average force seen in a previously tested 100 foot speed test, and the coach may monitor how well that is achieved.

Acceleration is a fundamental component of performance in many sports including ice hockey. The force measurement system can be used to optimize acceleration of athletes. Physics dictates that force is proportional to acceleration and the mass of the player. Higher forces applied in the direction of travel will lead to greater acceleration in that direction, for example whether it be in skating acceleration (straight line, skate in-line, turns, foot cross-over turns, etc.) or in slalom ski racing acceleration (out of the starting gate, rounding and exiting a slalom pole/gate, etc.). As a result, the force measuring system can be used for acceleration training and assessment. Coaches have access to how much force the athlete is producing and therefore can relate those numbers to how much they are accelerating. They will be able to assess but also prescribe training sets to optimize players' development. Common training strategies can be employed and include: 1. Focus on high force output to develop muscular power and 2. Focus on technique and less on producing high forces so that the player can apply the force effectively. On-ice/on-snow feedback on the kinetic and kinematic performance of the skates/skiis/boards allow the coaches and players to implement each strategy as best as possible.

Calculations of acceleration can be done using measures of force and modeling restrictive forces such as ice friction and air resistance. This allows coaches and players to view acceleration numbers and further develop acceleration training protocols. Alternatively, force measures can be integrated with direct measures of acceleration coming from indoor GPS, GNSS, RTLS technology, image based solutions and/or dead reckoning systems. Integration leads to higher levels of precision and the potential for new measures to be calculated.

The present system can be used as a new power training tool for edging sports. One application involves having players do drills over set distances. The user can use any means to measure those distances. For example, they may use traditional measuring tape or modern methods such as indoor positioning tools (ex. Indoor GPS) to automatically calculate the player's velocity at any one time. Either way, the software will know the distance between the start, the end point and any point in between as long as they were determined by some means. The software also knows the time it took to go from those points and the amount of force the player produced. The software then calculates the players velocity between two known points in space and multiplies that number by the force produced to derive power. With this information the coach or user can conduct power tests, monitor power output in practices and games and prescribe training using power levels as the guideline. This provides coaches with a new, objective and precise means to identify talent, manage injuries and optimize performance.

The system of the present invention can also be used for asymmetrical analysis, where right and left comparisons of the player's two skates can be done to identify asymmetries in technique, muscle strength and neuromuscular coordination.

The system also has applications in sports medicine, where injured players can be re-tested when they are ready to skate on the ice again. Use the data to ensure asymmetries are minimized and strength, agility and quickness is near normal so that the player can play without unnecessary risk of re-injuring themselves.

Players, coaches, equipment managers and manufacturers can use the force measured to determine optimal skate design. This has been done by Bauer with their research institute at McGill. However, with this new invention, players, coaches and equipment managers can now test different skates, holders, blades, insoles and other modifications to see what performs best for that player. For example, it is now easy to swap skate blades on and off. A player could try different blades made of varying materials, heights, composition, profile and sharpening to see what combination best works for them.

### Sample Data

The aforementioned ROFD determination is a way to combine the above measures to see how explosive for example, (ROFD divided by body weight or “BW”) the athlete's steps are. In this example, step results are calculated for 1) average of all steps from push-off to the final step; 2) Push-off; 3) average of the first three steps; and 4) average of steps 6 through 11 (speed strides). Although not in the following tables showing output data from the system for the above test, left and right comparisons can also be calculated to see if asymmetries exist.

Tables 1-4 illustrate how these values can be compared among different players for talent identification and benchmarking purposes. A good junior level player (Jr.A) is used as the benchmark to identify the target or goal values for players on the team in question.

To better illustrate use of the system output, sample data from a test performed on two players is outlined in FIG. 36. Both players were compared to a higher level Jr. A player that was much faster in the 100 foot speed test (from a standing start). 0.25 seconds separated player 1 from player 2 over the 100 feet. Without using any other tool (e.g. video), the sensor skate can tell coaches whether the players should 1) improve their force per step and/or 2) Improve their quickness (step time or stride rate).

From the output data, the coach can determine that player 1 needs to work on their step time (ie. stride rate) whereas player 2 is the opposite and needs to work on higher forces in that player's stride. It is up to the coach to decide how this is done, but almost certainly requires a combination of technique and conditioning work. A skate coach could work with the player on the ice with a variety of drills and show the player the results when an intervention (a change in how they skate) really improved the scores in the right direction. A strength coach could setup a training plan to improve their scores and periodically retest to ensure the player is adapting and improving as planned. The training plan can then be optimized by the coach to ensure goals are achieved in as short of time as possible. The player may be provided with access to his or her own data and analysis (such as above) from home.

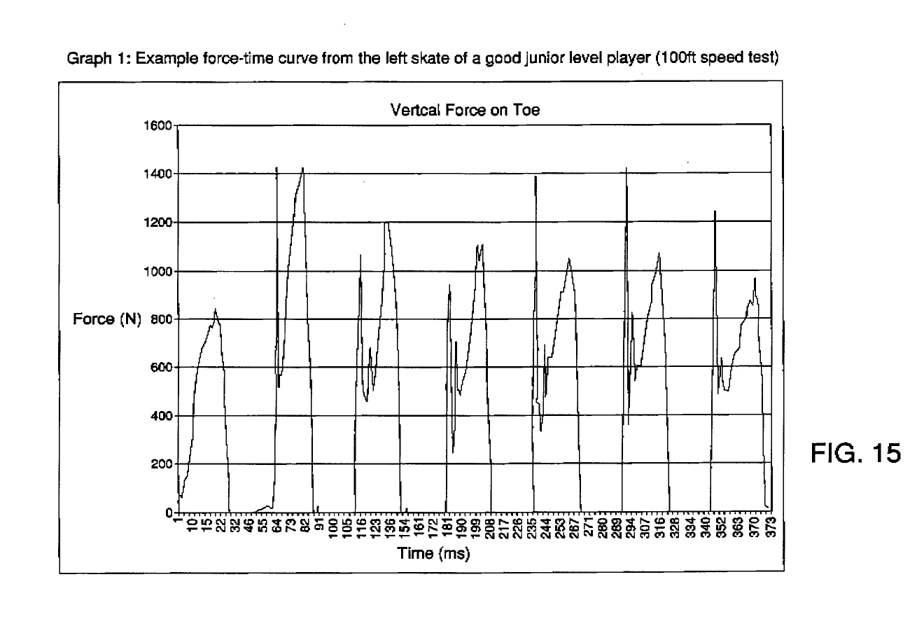

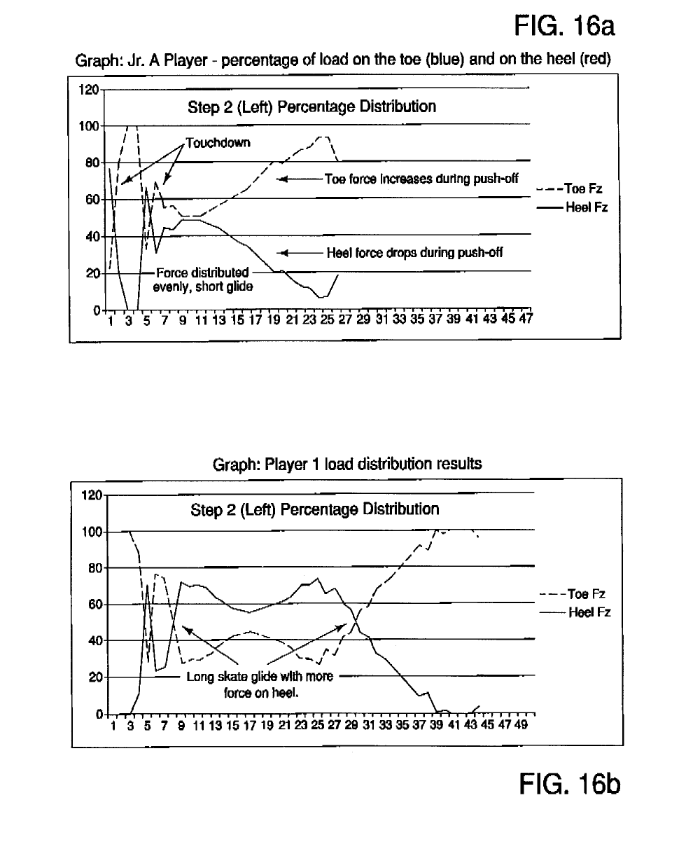

FIG. 15 shows an example of one type of output graph generated and displayed by the software using the process data, specifically a force-time curve from a good junior level hockey player. FIG. 16a shows another output graph that plots the percentage distribution of force between the heel and forefoot of the skate during a single step by the junior level player in the 100-ft test. Comparison against the same type of graph for Player 1 in FIG. 16b can be used to determine that the overall step length for Player 1 is too long compared to the Jr. A, the (faster) player, the glide/support time of Player 1 is much too long, and too much weight is placed on the heel by Player 1 during the glide/support phase of the stride. Such determination can be used in specifically training the player to address these performance shortcomings.

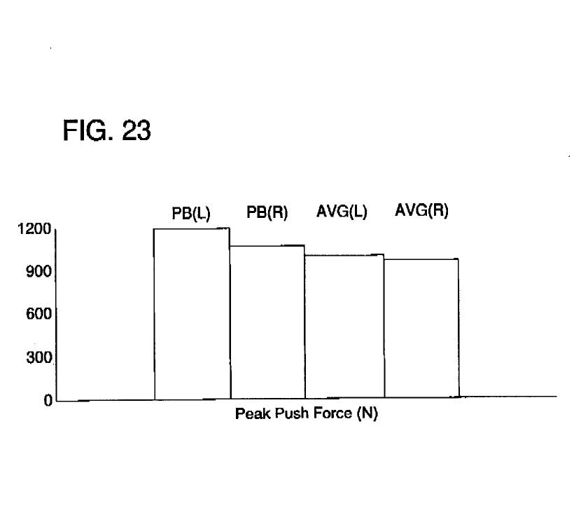

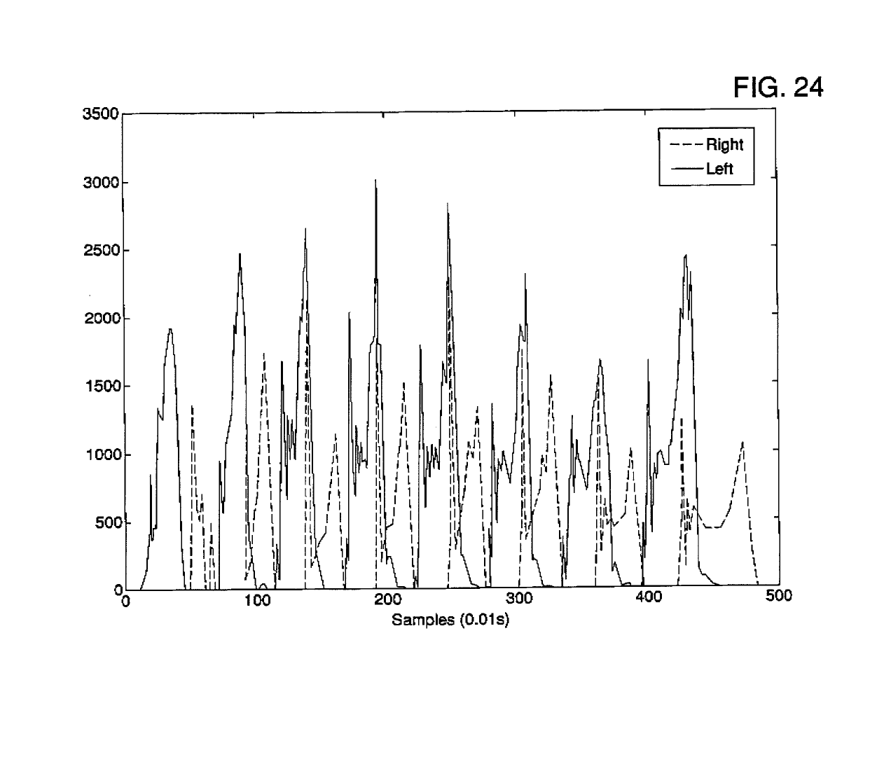

FIG. 23 shows another output graph that highlights the differences (i.e. asymmetries) between left and right legs. Those differences can be expressed as personal records (PR) or average scores across any number of steps. A large difference can be a red flag to coaches that the player is being inefficient and may also be susceptible to injuries in the future. FIG. 24 is a graph of both the right and left leg steps synchronized in time. Allowing the analyst to look at the coordination of the players steps with the goal of optimizing skating technique.

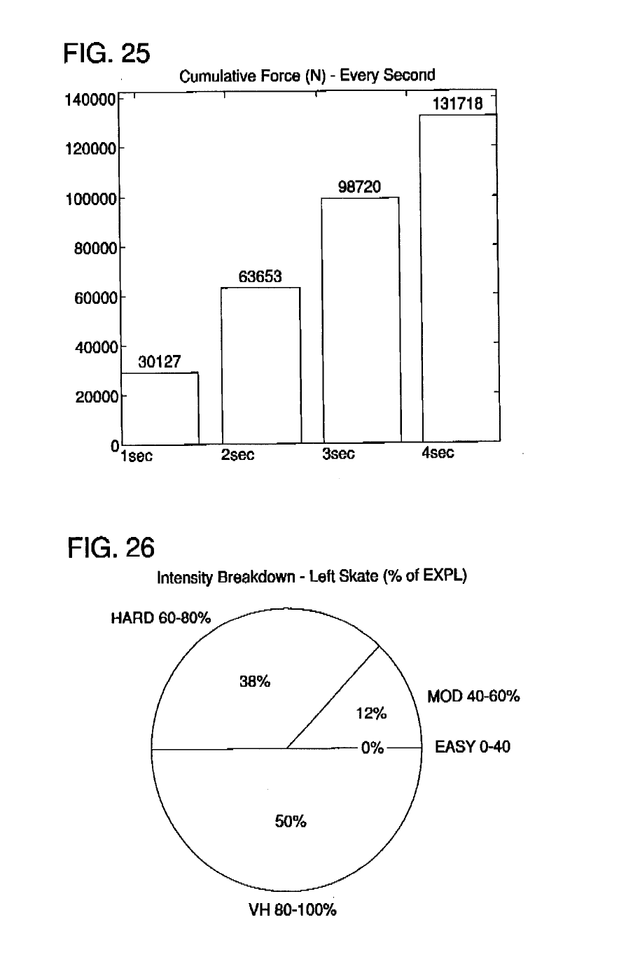

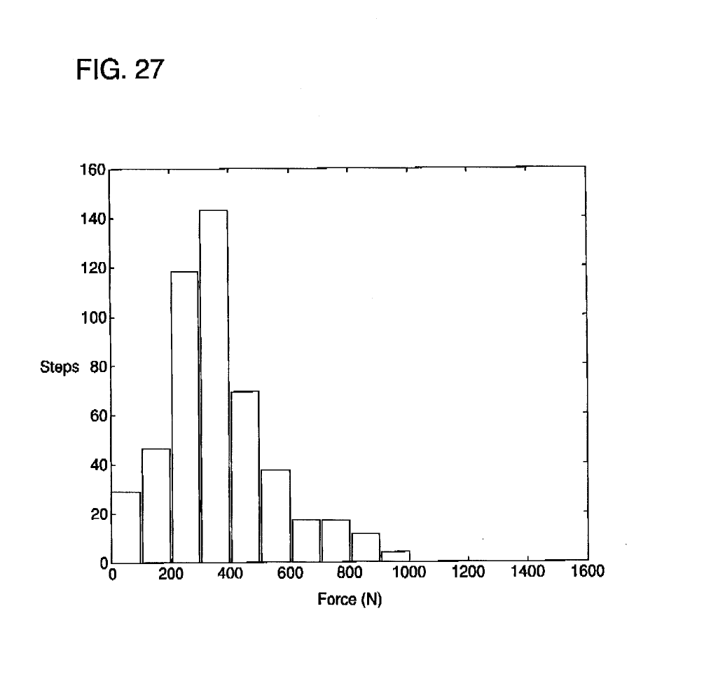

Output graphs of skating intensity and workload are shown in FIGS. 25, 26 and 27. FIG. 25 shows to total amount of force exerted within each second. The more force produced per second, the more intense the player is skating. FIG. 26 represents intensity from an entire skating session or subset of that session. Data used can be any set of data that represents the total amount of force exerted over time with or without respect to bodyweight. The amount of steps occurring within a certain range was then displayed in the pie chart. For example, 38% of the steps on the left skate were within 60-80% of their highest score and were thus labeled hard. Intensity and volume of skating can also be depicted in a histogram. FIG. 27 shows the number of steps that occurred at varying force levels. The total number of steps in the plot shows the volume of skating done.

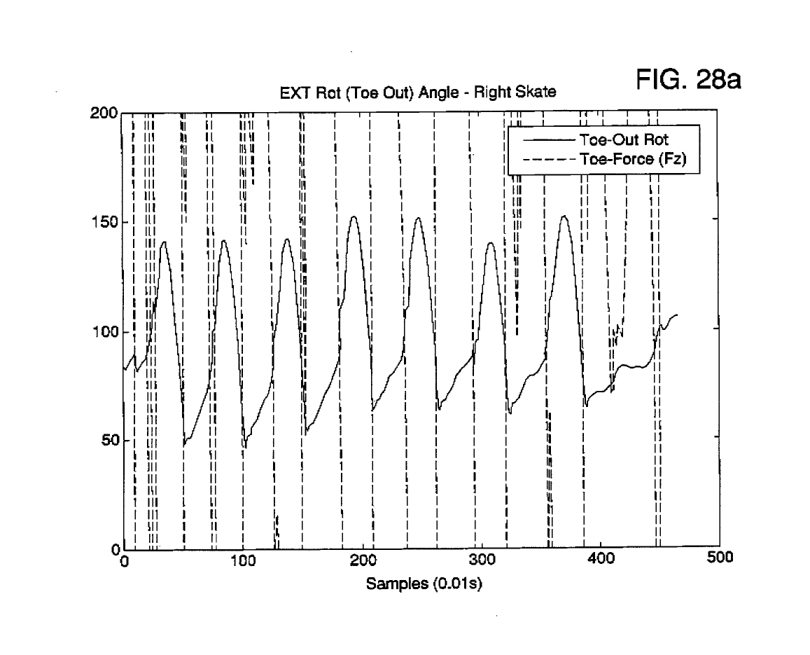

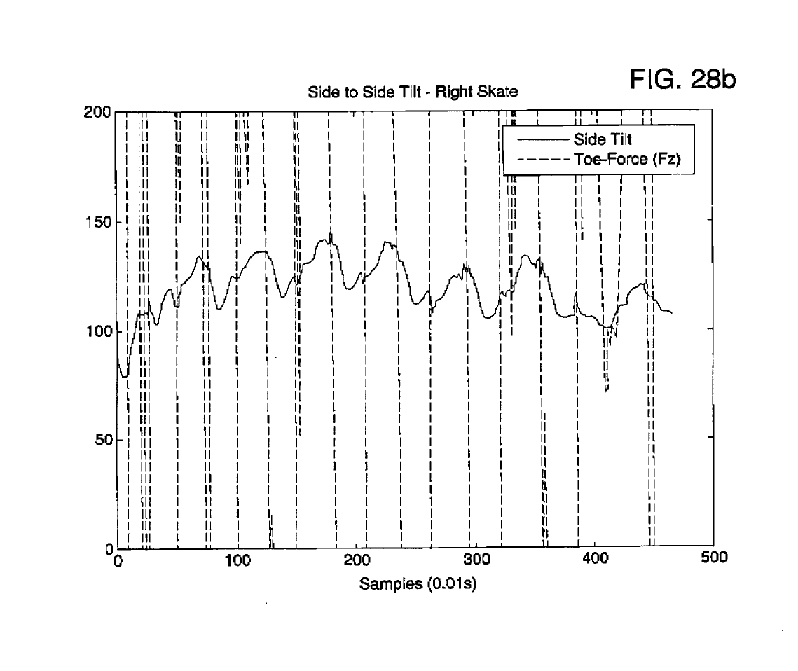

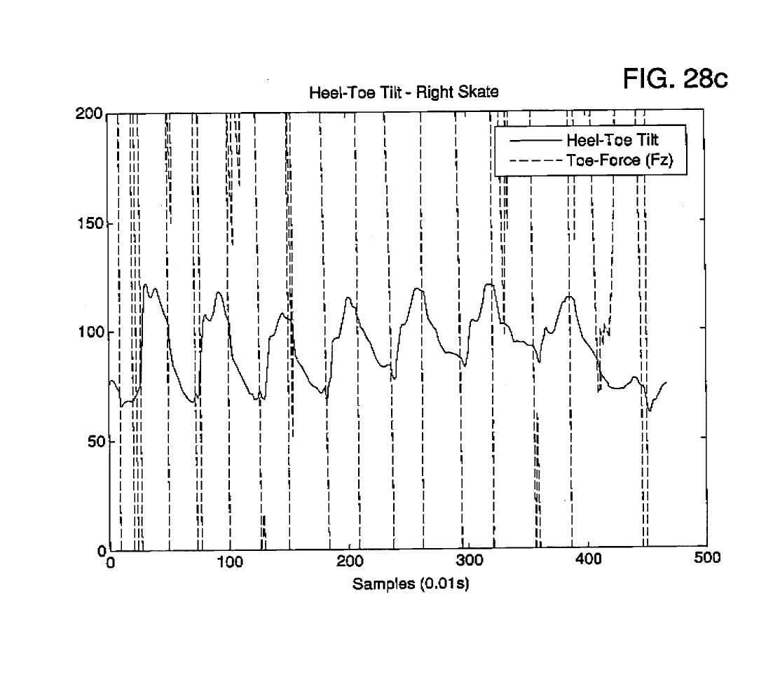

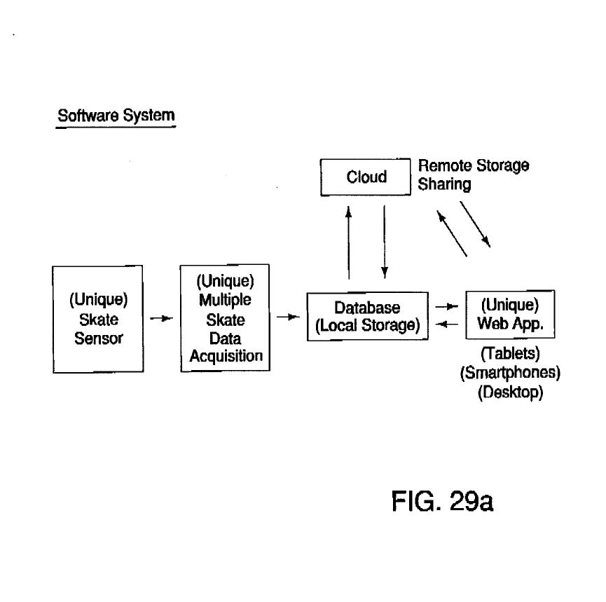

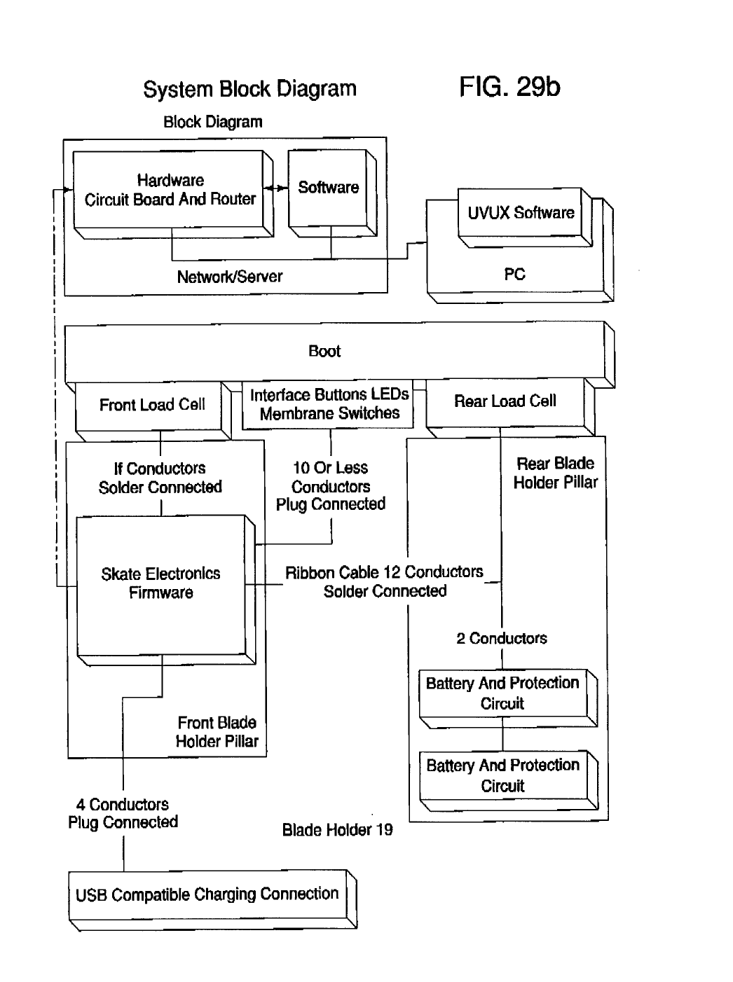

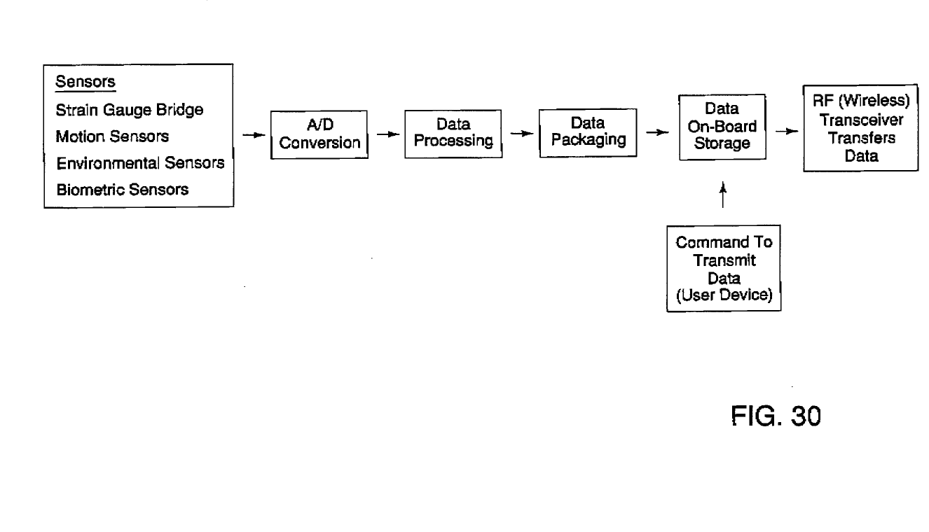

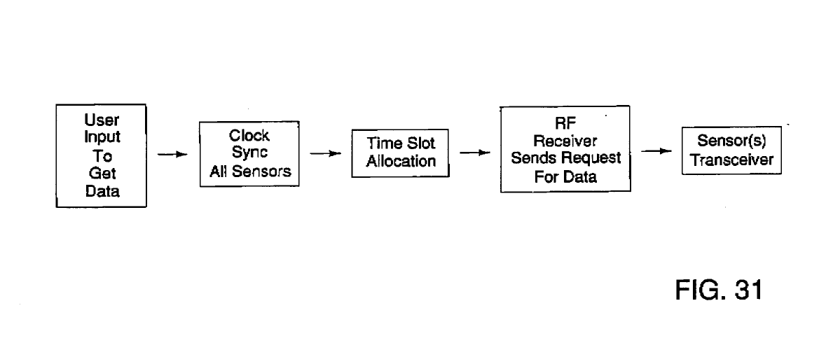

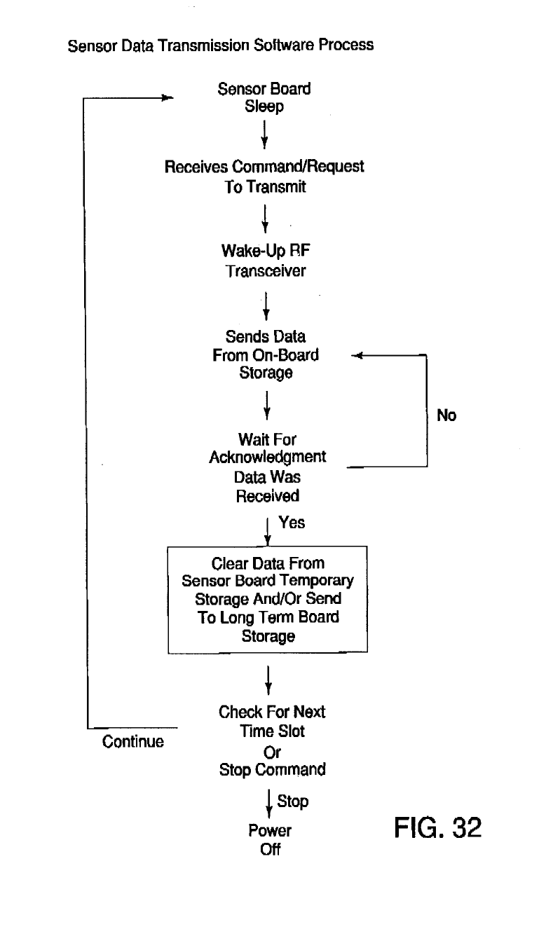

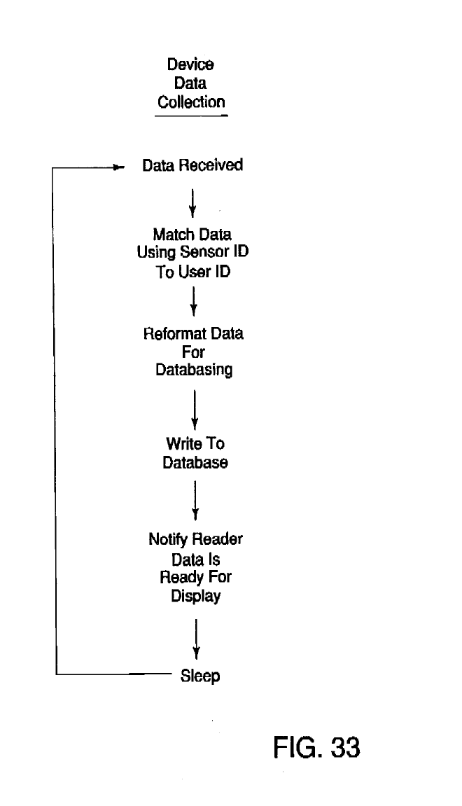

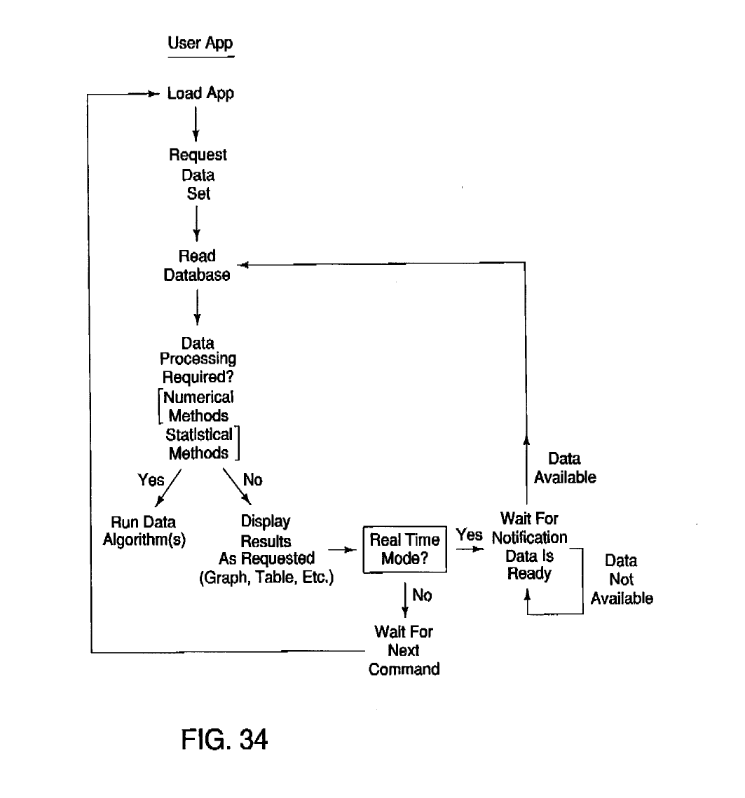

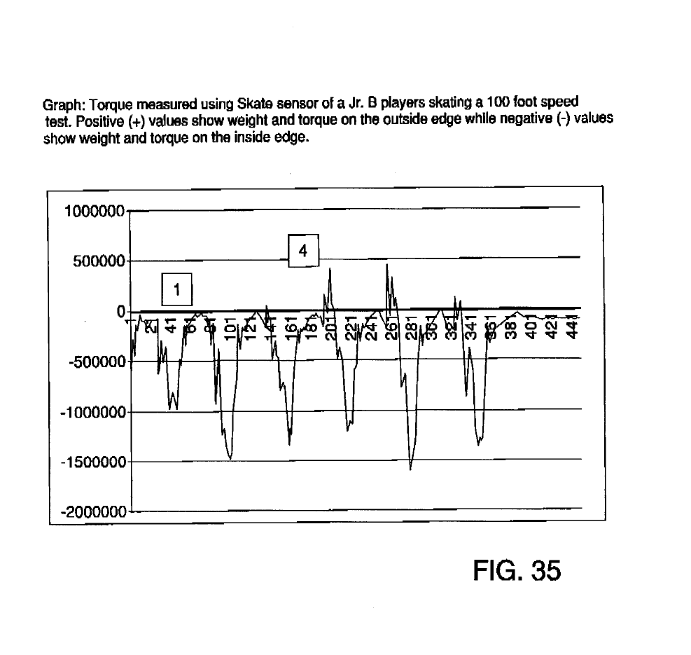

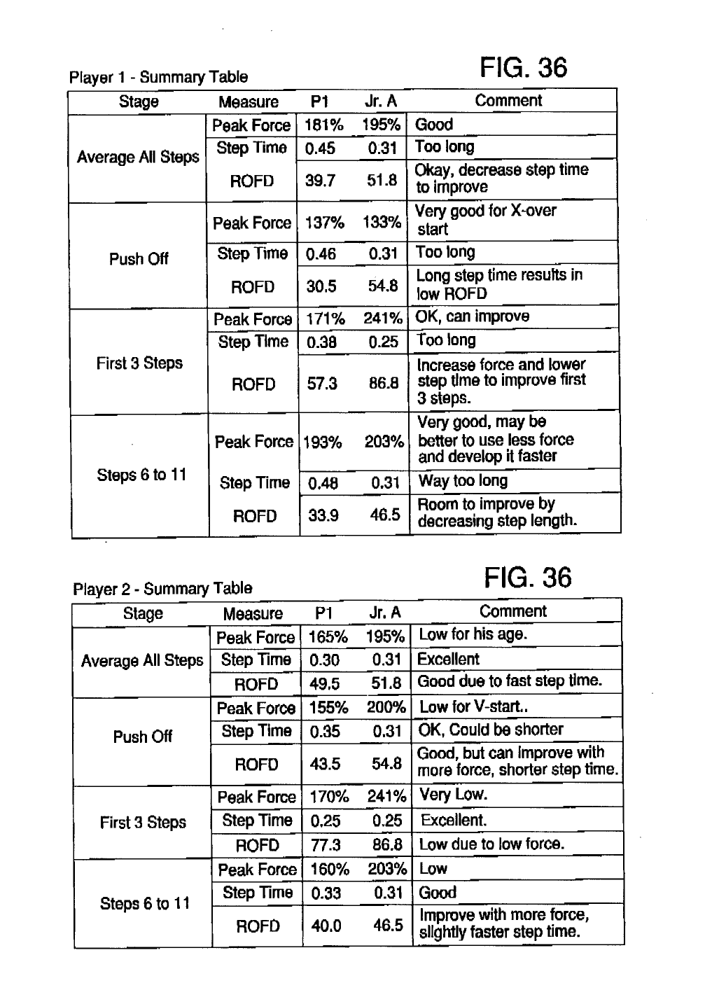

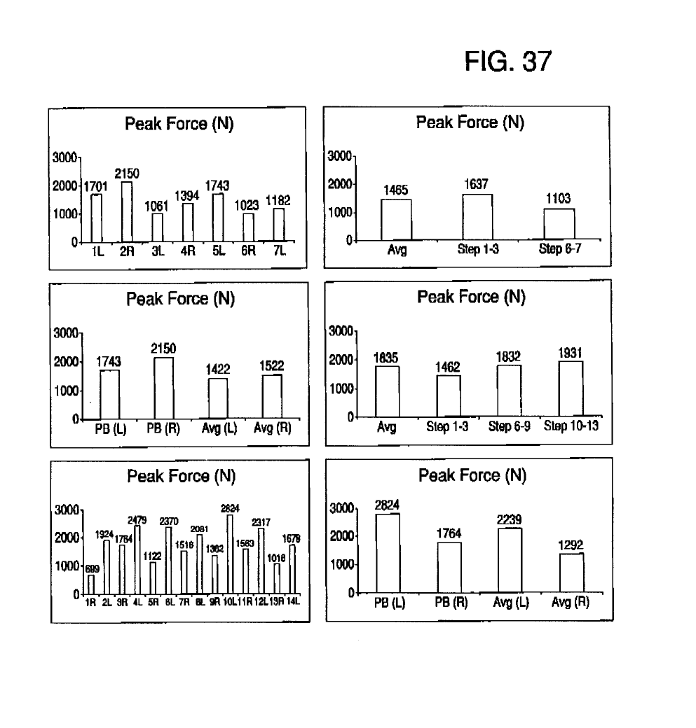

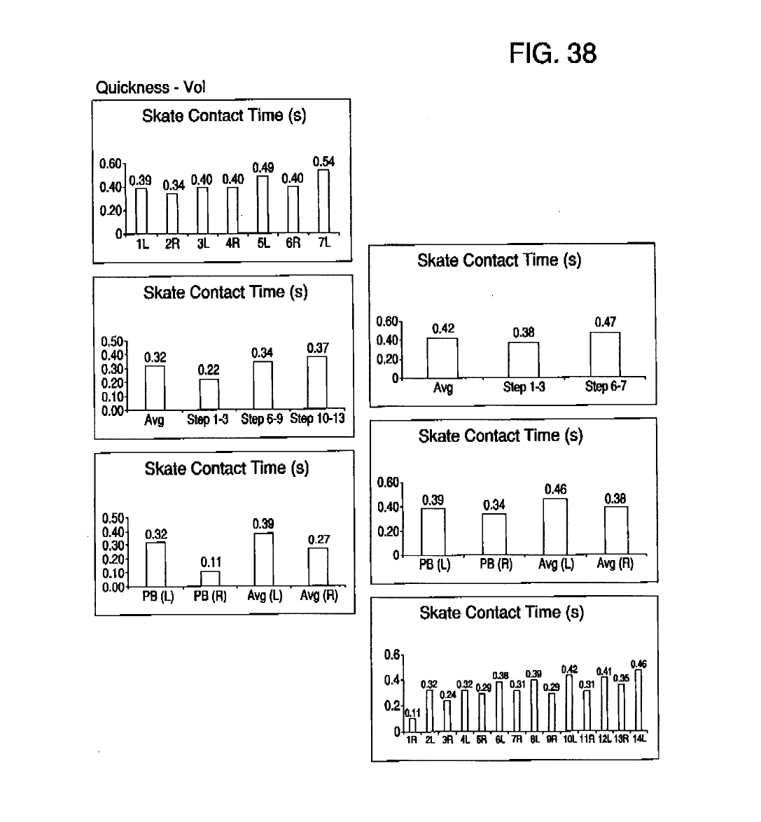

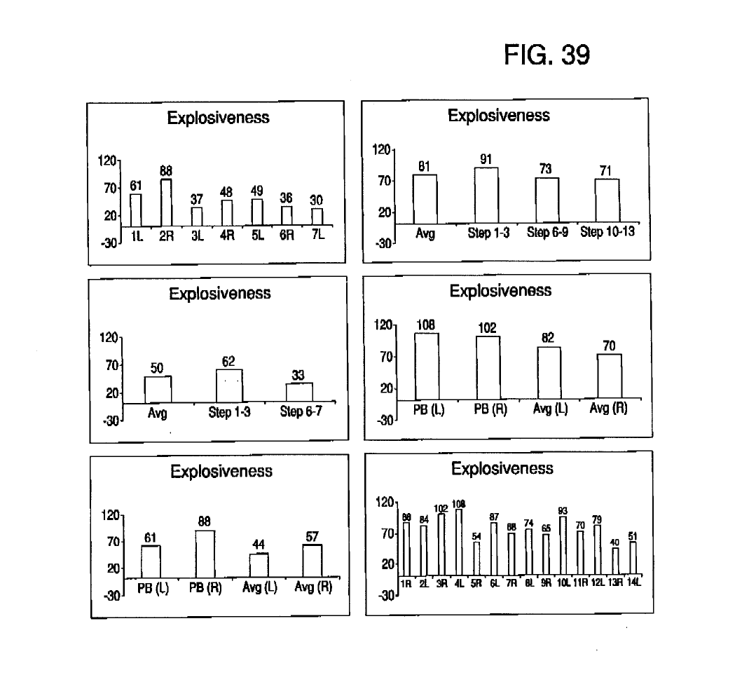

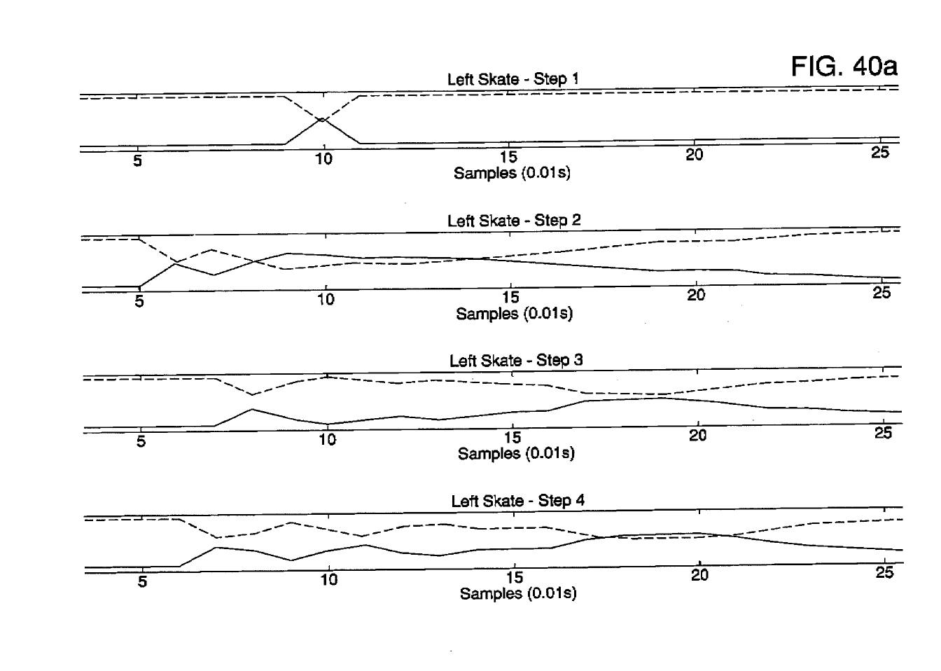

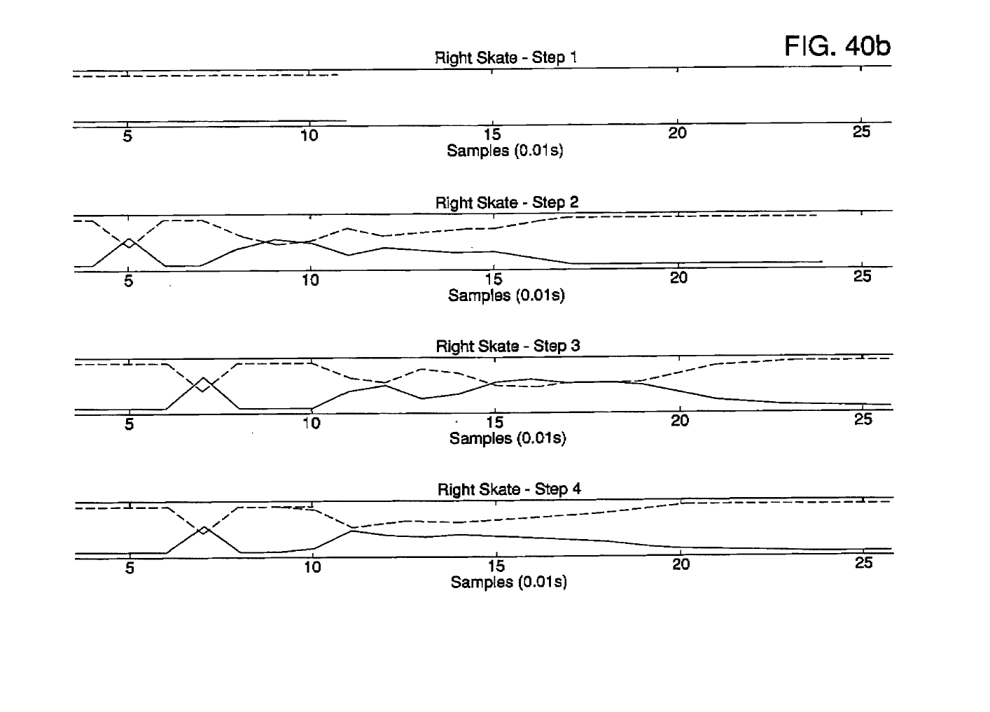

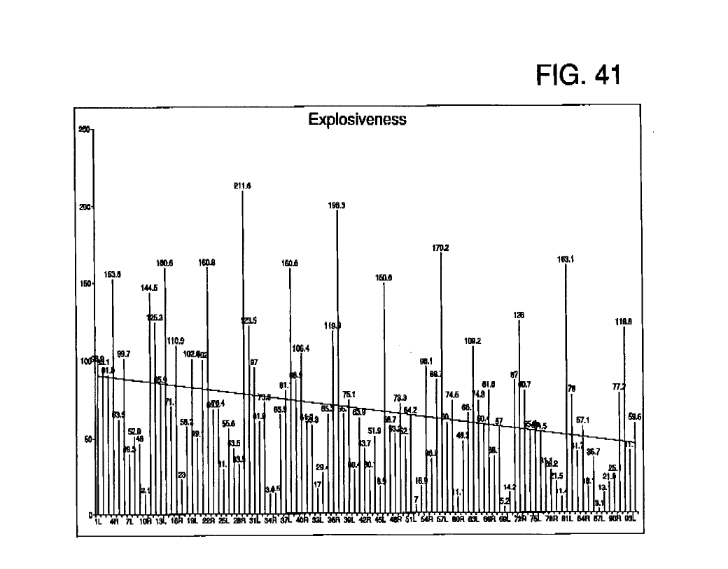

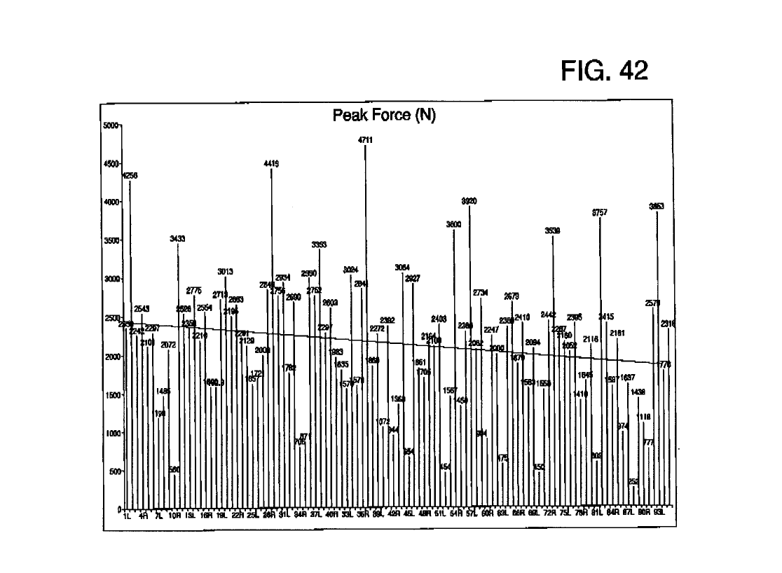

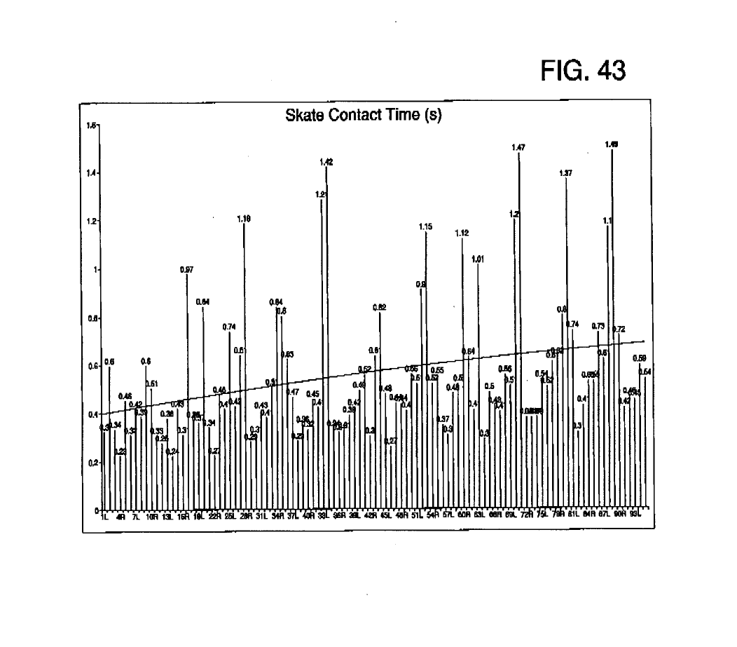

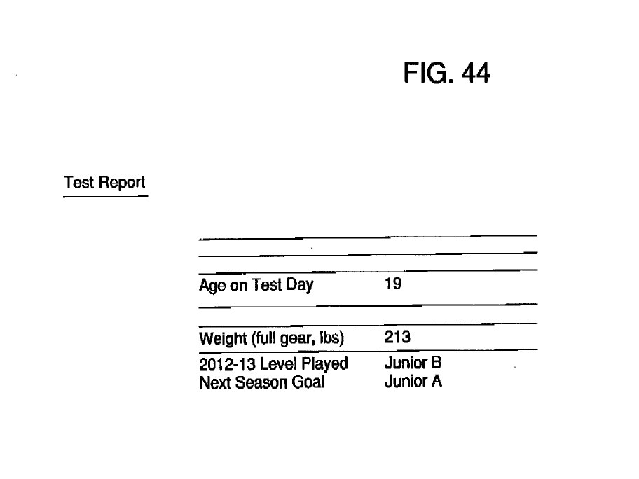

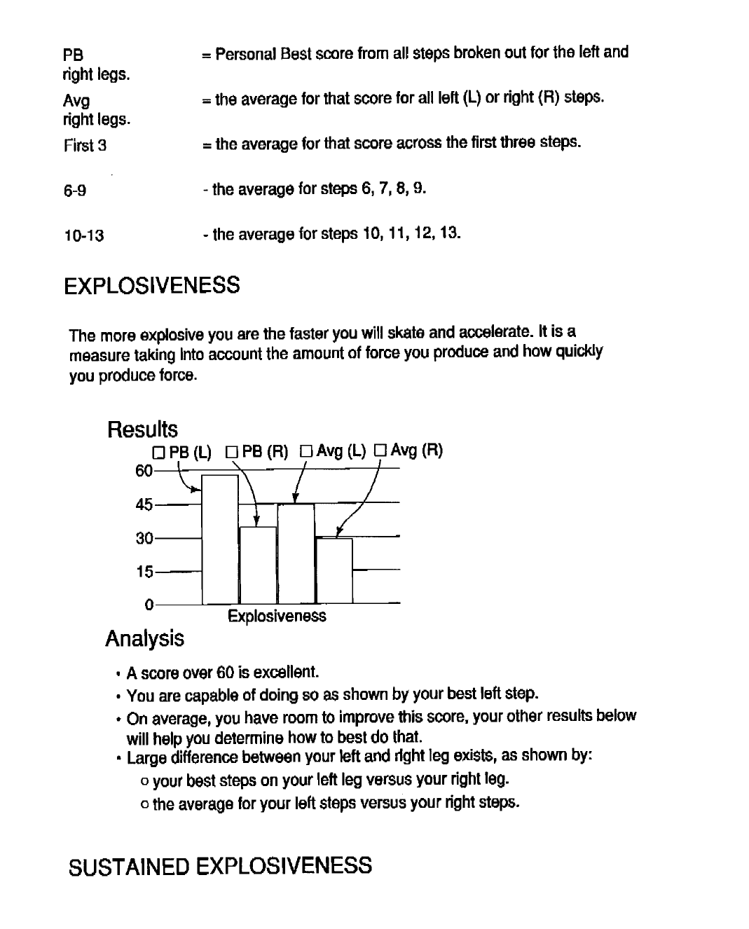

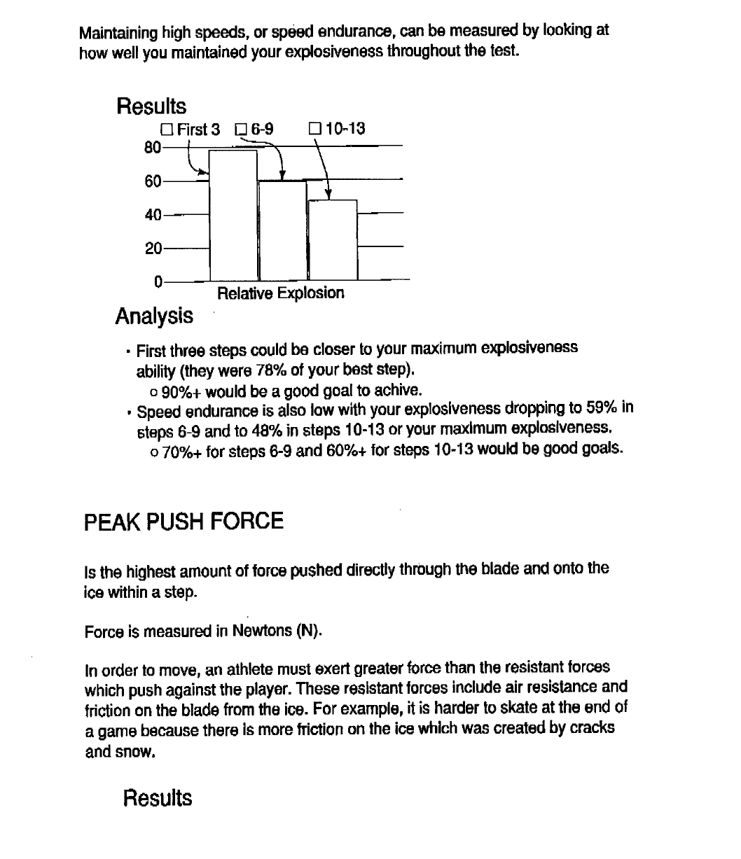

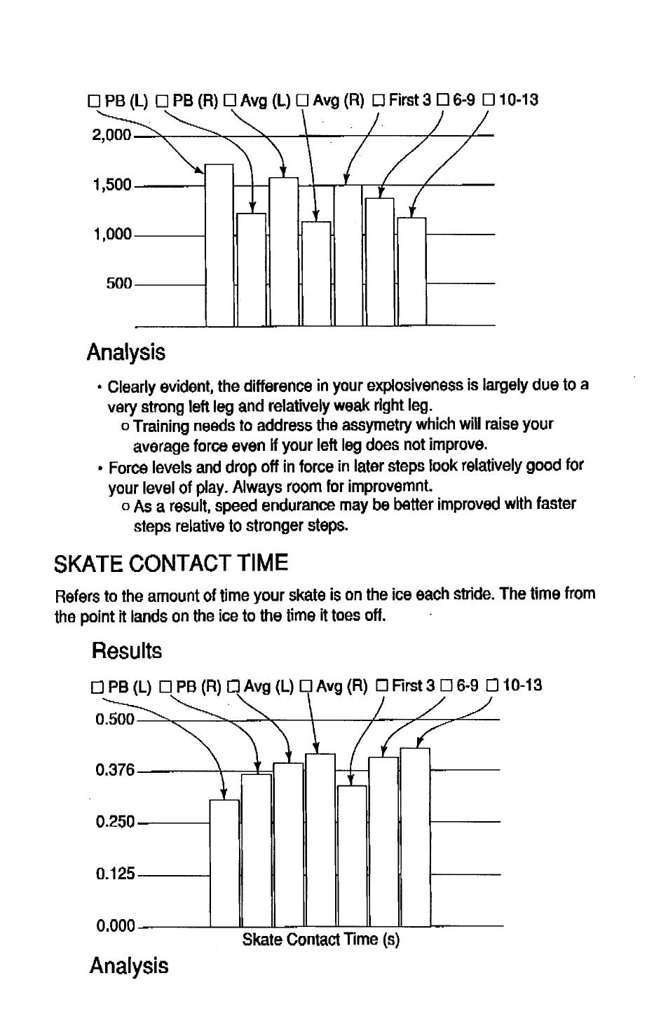

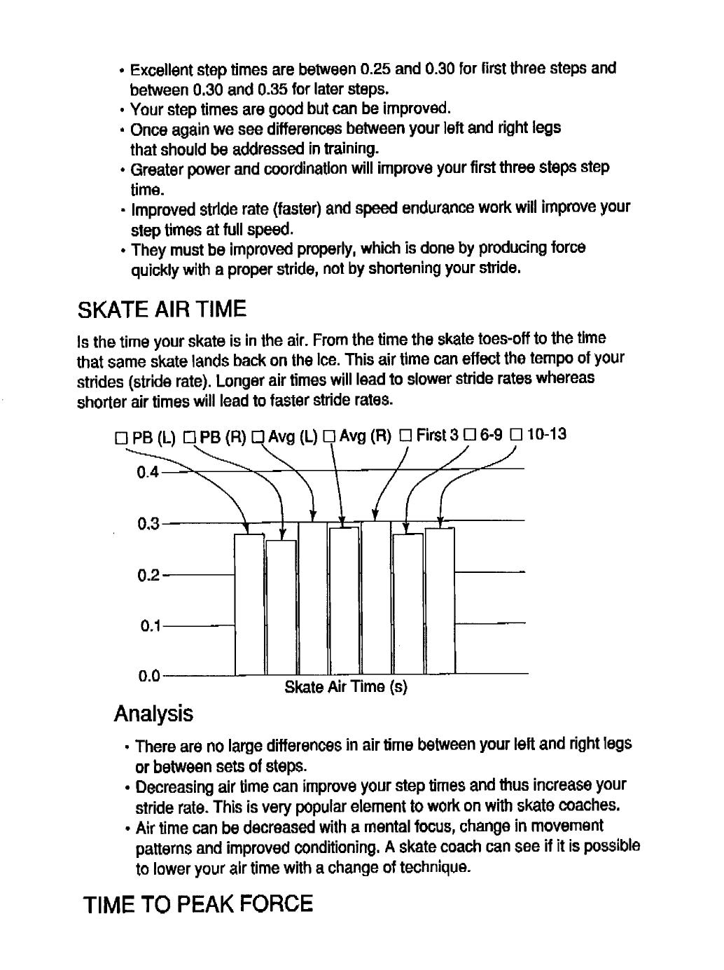

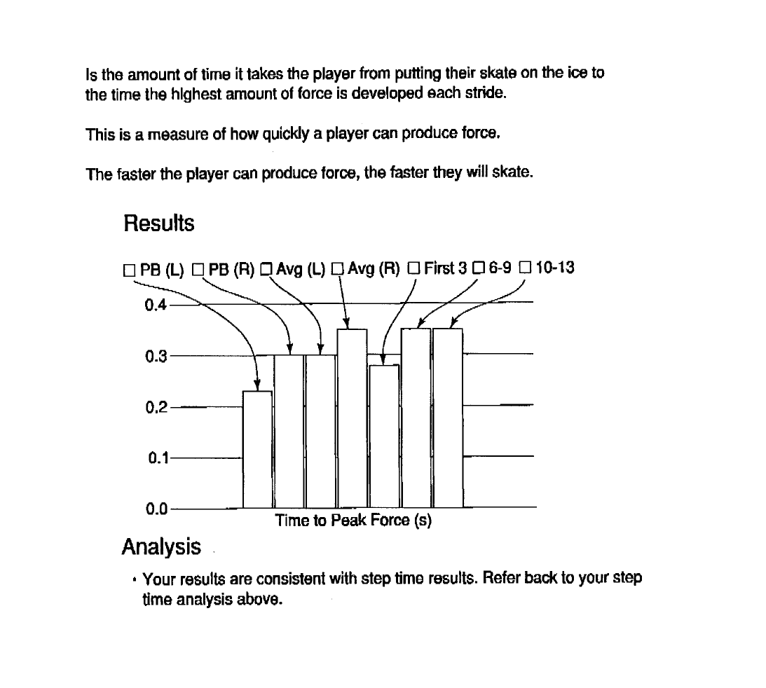

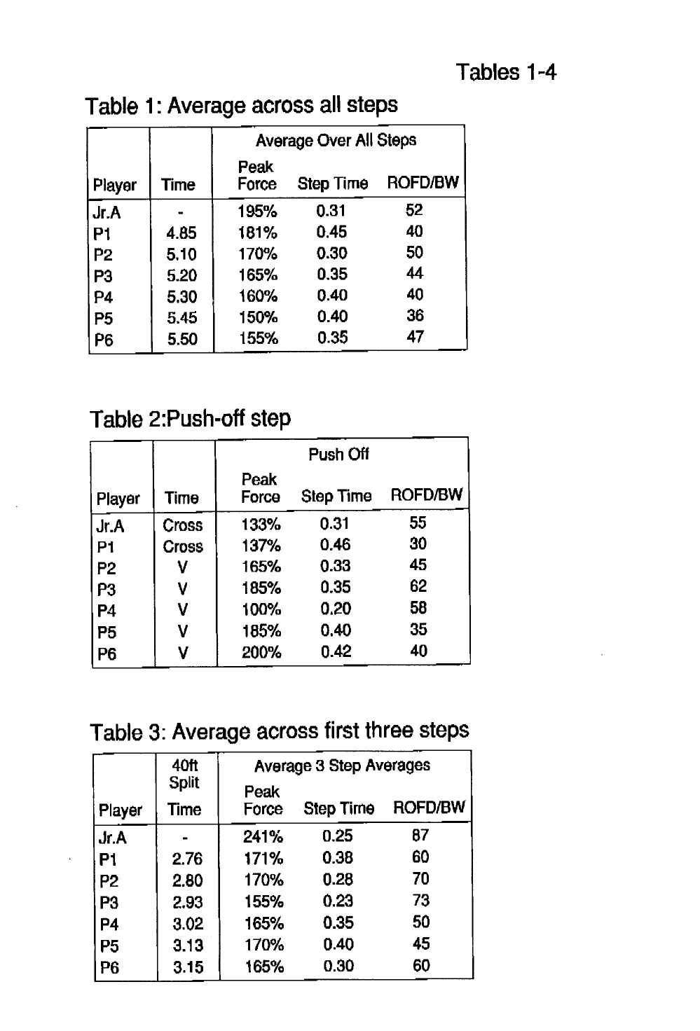

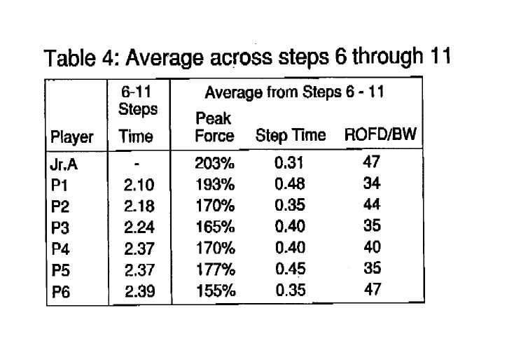

FIG. 28 is an output graph of the angles calculated during the skating stride indicate the level of skill, intensity and volume of skating being done. Ideal ranges for each angle exist based on the individuals' proficiency and their own personal characteristics. External rotation (toe-out), heel-toe tilt and side to side tilt can all be displayed according to one aspect of the present invention. This data can be used solely on its own or synchronized with force data. The force data helps describe events that occur in the angle data making more easily read by viewers. Such as touchdown, peak force and toe-off.

### Performance Testing and Analysis

As described herein, the invention includes a performance analysis system for edging and near-edging sports including ice-skating, skiing, and snow-boarding sports (edging sports); and inline-skating (wheeled) and skate-boarding sports (near-edging sports). In the example of hockey, which is not intended to be limiting, the system in its various embodiments provides data on: how well players skate; how hard they skate; and, how much they have skated.

Sensors on-board an athlete's footwear provide objective data, including some, or all of the following depending on the sport and the embodiment of the system being employed: the strength of each stride, explosiveness, quickness and weight distribution.

In an experiment, a volunteer skater (named Vol in this report) put on an alpha prototype and did a variety of skating trials. Vol was an accomplished 13 year old hockey player.

Data was collected with Vol doing: quick forward skating from a standing position; quick backward skating from a standing position; cross-overs; and tight turns.

Analyzed data from Vol was then compared to a recently retired professional hockey player (referred to as Pro).

The system measures the strength of the players stride by calculating the highest amount of force pushed directly through the blade and onto the ice within a step. In other words, this is done by calculating the peak push force each stride.

In the illustrations of FIG. 37, Force is shown and accelerate measured in Newtons (N).

In order to move, an athlete must overcome inertia and exert greater force than the resistant forces which push against the player. These resistant forces include air resistance and friction on the blade from the ice. The inertia includes the total weight being moved (player plus equipment). For example, it is harder to skate at the end of a game because there is more friction on the ice which was created by cracks and snow. To be fast you need to produce a lot of force to overcome those resistant forces.

Step time refers to the amount of time your skate is on the ice each stride. It is the time from the point the skate lands on the ice to the time it toes off (for forward skating). Shorter contact times results in faster stride rates. Acceleration, explosiveness (a form of rate of change of acceleration), and speed are a result of force as well as how fast you can apply force. The shorter the contact time the better as long as you are still producing a lot of force as compared to the amount of mass (total weight) you are accelerating.

Skate contact time is directly related to stride rate. The shorter your skate contact time is, the faster your stride rate should be. The longer the contact time, the slower your stride rate.

The more explosive the player is, the faster the player will skate and accelerate. Explosiveness is calculated by combining player strength and quickness scores together. Therefore, explosiveness takes into consideration the amount of force produced and how quickly the force is produced.

In interpreting the on-ice test results, regarding Vol's strength:

Overall peak forces look good for Vol's age.

Large drop-off in force (but often happens at this age). Vol exhibits a weak first step, that could be due to doing a cross-over start (normal in that technique). If not a cross-over step, then this is a weak first step. Notice however a high force on the second step. This is desirable. Force in following steps substantially falls off, whereas the PRO player maintained or even exceeded the force seen in earlier steps. (1700-2000 N down to 1000-1100 N). Notice PRO maintains his force even in steps 10-13 (see 2nd row of graphs).

On average, there was only 100 N difference between Vol's right and left legs, which appears to be fine. Unlike the PRO who has a clear discrepancy between right and left legs (may be due to previous surgeries).

To Improve, Vol needs to:
increase basic strength through maturity appropriate strength training;
increase skating specific push-off strength with further on-ice technique and speed development work; and
increase basic strength through maturity appropriate strength training.

Regarding Interpretation of Quickness data from FIG. 38: for Vol, early steps were 0.34 to 0.40 s. As seen with PRO, it is important to have quick steps in the range of 0.20 to 0.30 s until gliding starts.

To improve Vol needs to: improve neural ability to produce force quickly (on or off ice speed work and exercises); increase basic as well as sport specific leg strength; work on technique to minimize glide or standing too long on the skate during initial steps; increase stride rate (lower step times) in later steps where there is a glide (ie. accelerate right through the boards); make sure in training to focus on L and R legs and make sure legs are extending to the same extent, as we see in the third graph a tendency for longer strides on the left leg (0.46 s) versus the right (0.38 s).

Regarding interpretation of explosiveness as seen in FIG. 39;

Skating is not just about high force or just about fast steps. There is an optimal ratio of strength (force) and quickness (step time). Explosiveness is how we take that relationship into consideration. Athletes/Players want to be explosive.

We see good levels of explosiveness in Vol's steps 1 and 2 and noticeable drop-off in following steps. In comparison, PRO has good initial steps but continues to explode through steps 3 and 4. We do see a drop-off in explosiveness as PRO starts to glide. But the values stay relatively high due to his shorter step times and force maintenance (that we saw in the previous results).

To improve; and since this measure includes force measurement and step times, these values will improve based on the recommendations provided above.

### Interpretation of Weight Distribution

Regarding Vol's Weight Distribution as seen in FIGS. 40a and 40b: 0.38 s first left step with no heel force after 0.15 s. More variability in balance between all left steps. Right has more heel force in first step than left. Less variability, reaches 50/50 distribution for longer periods of time.

Weight is too far back on the heel of the left foot (blue line) in the early steps. That slows step times and rate of force production.

By viewing the graph, we see Vol is on the heel for about 0.10 s. If that time on the heel is removed, his steps times would greatly improve to 0.20-0.30 s in early steps on the left leg.

The right leg appears better, yet, we still see the extended period of time taken “sitting” on the foot before more and more force is transferred to the toe of the skate during the push-off.

To Improve: Vol should focus on getting more forward on the left foot to get more even distribution of weight. As previously mentioned, strength and on-ice training will improve Vol's ability to produce faster steps on both legs.

These test results demonstrate how the skate sensor system can benchmark a player's performance. Retesting over periods of time provides a way to optimize training that the player is undertaking. The player's skate and conditioning coaches can identify specific weaknesses and make sure the player is developing appropriately. This monitoring thus helps the coaches and the players.

### Pro Results in a Fatigue Test:

The following test was not done with the Vol but is shown as a way to demonstrate how the system can also be used for conditioning in older players. PRO skated back and forth between each blue line till exhaustion. As seen in FIG. 41, we see a large and relatively consistent drop-off in explosiveness as the player fatigues. The slope of the trendlines as well as, its shape (linear or exponential decay) will represent the player's level of fitness. Since explosiveness is a measure of both the step time and peak force, additional graphs are presented and analyzed to see if the player had longer step times and lower forces as the test progressed.

Peak force for every step was plotted for the entire test as seen in FIG. 42. Can see the gradual decline in peak force as represented by the trend line.

Not only did we see a decrease in force by we see a large increase in step length. It is also interesting that there is an inflection in step time as seen in FIG. 43. That is, the difference step to step decreases as the test progresses. Where the inflection in the curve occurs will be a marker for fatigue and thus a measure of fitness for the player.

The disclosed system provides athletes/players and sport practitioners (such as coaches/parents) a means to attain quantifiable data about the athletes/players patterns of force development, the amount of forces they produce, kinematics of limbs and whole body kinematics. An example of a test report form of feedback is shown by way of example in FIG. 44. To summarize, this system may provide one or more of the following: accurate and reliable measures of force over time taken underneath the athlete/player; accurate and reliable measures from kinematic sensors embedded in their sport equipment; accurate and reliable measures of kinematics of their entire body with sensors placed on the hip or torso; stored data from the sensors in the sport equipment and/or wirelessly transmitted data during or after movement to a handheld processor device or computer; is powered by an on-board battery source; and, uses mobile, computer and web software applications to store, analyze, display and share the data on handheld devices or computers.

The system may be assembled into off-the-shelf sport equipment products; and may include attachments that are designed to fit specifically for each type and size of sports equipment.

Advantages of the above described system over the prior art may include that the solution disclosed herein is designed for sport equipment and performance monitoring and feedback to enhance improvement in performance. One embodiment of the present system may be relatively simply affixed or removed using common hand-tool (e.g. a screwdriver, hex tool, etc.).

One embodiment of the present system is affixed mechanically, ie., no adhesives are required to be used to attach the plates to the bottom of the sole or to the top of the remaining pieces of sport equipment (ie. blade holder in skates, boards and ski's). Mechanical fixture design may be better suited to handle the loading and level of forces seen in skating and skiing versus that seen in standard footwear applications.

Each load cell may be made from a single block of material, such as for example an alloy metal provides one relatively low cost way to build the load cell.

There may be provided in one embodiment two loads cells on each boot (four per player) ie. toe/heel for which are all completely decoupled from one another. This allows for complete independent force measurement under the toe and heel.

The load cell may be designed so that the outer geometry can be shaped (i.e.

machined) to match the profile of the boot and bottom piece of the sport equipment. This allows the same basic load cell block design to be used for different brands, sizes and types of sport equipment. The block is initially built for all types and then refined for a specific pair of skates or ski boots. This lowers manufacturing costs and optimizing the performance of the load measuring system by ensuring a clean, quality fit for each skate.

The present system can therefore be retrofitted into commercially available products. Thus customer does not need to buy a specialized skate boot or blade holder. They can purchase a skate from a common brand at a hockey store and then assemble the system of the present invention into it. Or the installation can be performed for the customer.

Fore/aft forces need not be measured in this system for edging sports, making it less complex and more affordable. This is appropriate for sliding/gliding sports where there the blade/board interaction in the fore-aft direction with the sport playing surface is low and has little or no relevance to the athlete in terms of technique or conditioning performance improvements. However, it will of course be appreciated that strain gauges for measuring forces in the fore/aft direction may be included in other embodiments, either as standard equipment or a customization option based on consumer requirements.

Toe and Heel measurement areas allow the coach and player to look at load distribution during movements. In skating, there is a surprising variance between players depending on the time spent with smaller or larger loads on the toe versus the heel. The way the skater loads the skate in a stride is very important to performance whether it be forward or backward skating. Good backward skating technique requires more load on the heels by proficient players. And, backward skating is an important movement in ice hockey and figure skating, unlike footwear (shoe) based systems used in contexts where there is little backward movement, and under any such backward movement, the loads are mostly on the forefoot (e.g. backpedaling in American football). It is also surprising to see that the highest loads

Applicant has measured to date are on the heel during a tight turn in skating. With four load cells on each player, in analyzing a hockey player's performance it is possible to watch load distribution to optimize shooting and stick handling as well.

Both skating and skiing are edging sports. In order to change direction, accelerate or decelerate significantly, an edge has to dig into the surface. Load distribution is very important in order to control the edging, both from toe to heel, as well as from inside to outside. Footwear requires surface area of the outer sole or cleat friction to make those changes, and does not have built in edges to dig into the surface. Thus is it vital to consider how the forces and their loading patterns relate to edging performance in skiing, snow-boarding, and skating.

Skates, boards and skis typically have two distinct contact points between the sole of the boot and the blade holder or ski binding, whereas footwear has one large surface in contact along the length of the shoe. Thus, loads need to be measured in both areas in order to know the total load exerted by the athlete on the equipment and subsequently the playing surface.

It is expected that at least some of the prior art will significantly alter the performance of the walker/runner in a footwear system. The prior art systems do not allow regular footwear to behave normally. That is, they do not allow regular flexibility in the footwear to occur since they usually have to stiffen the sole in order to properly adhere the system and measure the loads effectively. In skating and skiing sports, the boots have stiff soles already. The present system does not impair the functional flexibility and thus performance of the skate or ski boot.

A monitoring and training system is also developed independent of force measurements but using all, or, a portion of the measurements captured from the accelerometer, gyroscope and magnetometer. Acceleration values and patterns are used to indirectly measure the amount and intensity of movement. One example includes using the acceleration and velocity measured and calculated. If not used as precise or direct measures of acceleration and velocity then the changes in acceleration can be grouped into the amount of activity done at intensities such as for example very hard, hard, moderate, steady, easy and light. Amount of steps and glide time can estimate the amount of skating of volume.

Also, independent of force measures, software algorithms may use angles derived in typical means from the accelerometer and/or gyroscrope and/or magnetometer. The angle of the skate or ski or board in and of itself is useful information about the quality of performance of the athlete. For example in ice hockey, coaches tell players to land with their skate at an angle of about 45 degrees from straight ahead instead of straight forward. This allows them to push immediately off the skate. Whereas, when the players attain speeds where they start to glide, the skate will be straight forward or an angle less than 45 degrees. Coaches typically want players to push with the entire blade on the ice for as long as possible. By measuring the heel-toe tilt the coach is able to see when the heel starts to come off the ice and then to provide guidance to the player to make sure it does not happen too soon. The third angle measured is the side-to-side tilt of the skate. Proficient skaters are able to create greater tilting of the skate towards the ice. Also, greater angles of tilt will indicate the player is fully striding and thus working at a higher intensity. As players fatigue, they stand up and have less leg extension. Therefore, the amount of tilting will decrease with fatigue and through measurement will show the skater is skating at a lower intensity. Analysts can review data from practices, drills and games to identify premature fatigue, illness or onset of illness and poorly conditioned athletes.

Another use of angles is for less developed players to determine when they are on their inside or outside edge. The use of both inside and outside edges are very important in ice hockey for the variety of movements required. Coaches with the system described herein can provide feedback on the ice or off the ice to teach skaters better technique.

The skate angle patterns can be used to determine the type of movement of the player. Examples include, if both skates are angled in the same direction then the player is turning in that direction. If one foot is angled differently than the other then the player is forward or backward skating. If both skates are angled the same direction and large vibrations occur on both skates then the player is doing a stopping motion. Forward and backward skating can be differentiated by using the amount of heel-toe angle occurring. In forward skating there is a large push-off on the toe and the heel rises. In backward skating there is very little if any heel to toe tilt.

Number of movements or steps or turns can be determined by measuring the number of rises, falls and/or peaks in the acceleration, velocity or angle measures. Events can include a change in movement as previously described (examples include forward skating, stopping, turning, skates in-line or crossing-over, backward skating). Time between peaks for forward or backward skating can indicate stride rate. Time between peaks or events or other distinct patterns will decrease with an increase in intensity (i.e. acceleration and quickness). Thus these measures from the kinematic sensors can be used as indicators of intensity. In summary, data from the inertial motion sensors can be used to describe the movement type, the quality of movement, distinguish movement events, movement volume and movement intensity.

The data from the inertial movement sensors on the skates can be combined with data that represents the centre of mass of the athlete. Combined, they will provide higher rates of precision for the aforementioned applications.

Relationships between force measures which are direct measures of intensity and the inertial measurements demonstrate how the inertial measurement system can be used independently from a force measurement system. Doing so, offers a low cost system that attains many but not all of the benefits through use of the force measurement system.

Either the force data or the inertial measurement data can be used to indicate when the athlete is on or off the ice. Skating force patterns mentioned previously are recognized by software to determine when the athlete was on the ice versus off the ice and not playing. Likewise inertial measurement data such as vibrations seen by the accelerometer in the skate during gliding on ice which would not be present while the player is on the bench would be recognized by the software as to when they step on or off the ice. Alternatively, thresholds in force, acceleration, velocity or angle could also tell the user when the player was on or off the ice. This data is valuable since coaches want to measure the amount of time the player is on the ice and the amount of time they are playing the game while on the ice. The later is determined using input from the game clock data feed or using the scoresheet and manually entering the times. The timecode of the sensor is synced when the game starts so that the game clock and scoresheet data can be synced with the sensor data. Since the software knows when individual players are on and off the ice that data can be used to code video. Segments of video would be created for each and every player. Thus automating slicing/editing of the video. During and after the game the videos can be sent directly to a player or coaching software account ready to view. This dramatically decreases the manual labour currently used to code video during a game.

The system may be used so that players are rewarded for accomplishments. For example, such individual accomplishments could include a best ever peak force or a best-ever ROFD over three steps for the player being congratulated. Cumulative data can also be rewarded. The player can be notified when a particular session was the most amount of skating they have ever done or that they held the highest level of intensity as compared to prior personal achievement, or as compared to the team statistics (eg.: congratulations, today you were in the top fifth percentile, or top 5%, etc.). Rewards can be virtual points, trophies and medals or even tangible rewards with partners that sponsor a competition. Players who standout based on their effort or talent level can be rewarded as well since they can be compared to other players in that game or under the same circumstances.

Another application is the use of this data to create video games. Data from actual players can be uploaded to dictate the skill level, energy level and other characteristics of virtual players. That virtual player can then play against machine driven players or against other virtual players that were also uploaded by other players from their sensors. As such, a player could play his friends across the country in an online game of hockey or race them in skiing and snowboarding. A player could also play on a virtual professional team against virtual professional players.

Since various modifications can be made in the invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A method for performance monitoring for edging or near-edging sports in which a pair of foot-worn boots are coupled to corresponding surface-engaging equipment which is manipulated by a wearer of the boots to control engaging of one or more edges or near-edges of the surface-engaging equipment with the surface beneath the wearer, the method comprising:
(a) providing a pair of measurement apparatus, one measurement apparatus of said pair of measurement apparatus associated with each boot of said pair of foot-worn boots, each measurement apparatus of said pair or measurement apparatus comprising at least one sensor, wherein said at least one sensor is adapted to cooperate with the corresponding said boot and the corresponding said surface-engaging equipment to measure and provide data corresponding to at least forces exerted on said surface-engaging equipment by the wearer of said boots,
(b) providing a data receiver cooperating with each said sensor to receive said data and to communicate said data to a data processor,
(c) providing a feedback mechanism to a user, said feedback mechanism cooperating with said data processor,
(d) determining in said data processor from said data, for each said sensor, at least the following characteristics derived from said data: force over time, a peak force of said force over time, delta time of any one of said force over time, explosiveness corresponding to any one of said delta time,
(e) providing via said feedback mechanism at least a quantum of at least one of said characteristics to the user.

35. The method of claim 34 wherein said each delta time corresponds to a step time.

36. The method of claim 34 wherein each said sensor is chosen from the group comprising: strain gauge, accelerometer, gyroscope, magnetometer, pressure gauge.

37. The method of claim 34 wherein said characteristics further include one or more of: power, stride rate, step time, angular roll displacement about a longitudinal axis of each said boot, angular roll acceleration about said longitudinal axis, side-to-side force, angular acceleration in pitch between heel and toe, instantaneous force, average force, peak force, time to peak force, start time of movements, time between movements, impulse, side-to-side torque about said longitudinal axis, force vector, force vector components in direction of motion.

38. The method of claim 34 wherein said explosiveness characteristic includes rate of force development.

39. The method of claim 38 wherein said characteristics are adjusted for a body weight of the wearer.

40. The method of claim 34 wherein said delta time of any one of said force over time is determined as a time interval between sensed vertical force loadings going to zero.

41. The method of claim 37 wherein each said sensor includes separate sensors associated with a heel portion and a toe portion of each said boot.

42. The method of claim 41 wherein said characteristics further include a load distribution between said each heel and toe portions of each said boot.

43. The method of claim 42 wherein the edges of the surface engaging equipment include a spaced-apart, substantially longitudially extending pair of edges under each said boot, wherein the edges are adapted to cut into water when in one or more of its various states, excluding any gaseous states, and including snow or ice, and wherein said edges are divided by said processor into a plurality of virtual zones, and wherein said processor is adapted to allocate said force distribution into said plurality of zones.

44. The method of claim 43 wherein said force vector characteristic is said allocated by said processor amongst said plurality of zones.

45. The method of claim 43 wherein each said pair of edges under each said boot is divided into four said zones, and wherein each zone of said four zones includes corresponding sections of opposite edges of said pair of edges so as to result in said allocation amongst one or more of eight separate sections of said edges.

46. The method of claim 37 wherein said processor is adapted to count said start time of said movements characteristic so as to thereby count movements of the said wearer and to derive a cumulative volume of movements characteristic of the wearer over time.

47. The method of claim 46 wherein said processor is adapted to determine frequency of said movement of the wearer and to combine said frequency of said movements with said force characteristics to thereby determine an intensity characteristic.

48. The method of claim 37 wherein said edging sport is hockey and wherein a magnitude of said intensity characteristic becomes greater as an angular value of said angular roll displacement characteristic is increased when other of said characteristics remain substantially constant.

49. The method of claim 37 wherein said sensor is adapted to sense roll about three independent, orthogonal roll axes of said each boot, and wherein said characteristics further include angular velocity and angular acceleration about each of said orthogonal roll axes, and wherein said processor is adapted to associate an intensity characteristic which indicates a greater intensity of said intensity characteristic with greater said angular velocities about said roll axes.

50. The method of claim 49 wherein said edging sport is hockey and wherein said processor is adapted to correspond a quicker said step time and said stride rate to a greater said intensity characteristic.

51. The method of claim 37 wherein said processor is adapted to correlate said impulse characteristic with time so as to determine a net impulse and an associated performance level of the wearer.

52. The method of claim 37 wherein said processor has a memory device cooperating with said processor, and is adapted to use said angular displacement characteristic to determine a sway of the wearer, and wherein said processor is further adapted, in cooperation with said memory device, to retain and compare a history of said sway of the wearer to thereby provide for correlation of said sway to injury causing events which have injured the wearer over said history.

53. The method of claim 52 wherein said injury causing events include concussions.

54. The method of claim 37 wherein said processor has a memory device cooperating with said processor, and wherein said memory device is adapted to store, for retrieval by said processor, historical records of one or more of said characteristics as measured by said sensors, and wherein said processor is adapted to provide one or more of the group of actions comprising: (a) monitor, (b) cause to be displayed, (c) determine trends in, (d) analyze, (e) analyze and/or trends in, and (f) report on, said historical records of said characteristics.

55. The method of claim 37 wherein said edging sport is hockey, and wherein said processor is adapted to determine one or more of said characteristics over three steps at said step times.

56. The method of claim 55 wherein said three steps are from a zero velocity of said wearer.

57. The method of claim 37 wherein said processor is adapted to monitor historical records of one or more of said characteristics and to determine trends correlating to fatigue of the wearer.

58. The method of claim 57 wherein said fatigue is from the group comprising: neuromuscular fatigue, metabolic fatigue.

59. The method of claim 57 wherein said fatigue is caused by the onset of illness.

60. The method of claim 57 wherein said fatigue is caused by a recurring injury.

61. The method of claim 37 wherein said processor has a memory device cooperating therewith and wherein said processor is adapted to store historical records of one or more said characteristics and to selectively retrieve said historical records for comparison and analysis of trends in said records over time.

62. The method of claim 61 wherein a set of previous performance records of a third party are provided and wherein said historical records of said wearer are compared and analyzed relative to said previous performance records of said third party.

63. The method of claim 62 wherein said previous performance records are high performance standards to achieve.

64. The method of claim 62 wherein said historical records are from within the wearer's past performance within a time frame chosen from the group comprising: last practice performance, last performance in competition, season-to-date, last season, lifetime, duration of a membership of the wearer to a subscriber version of the system.

65. The method of claim 62 wherein said previous performance records are those of team-mates of the wearer.

66. The method of claim 64 wherein said edging sport is hockey and wherein time-of-game clock data is provided from a game clock associated with a game of hockey in which the wearer is participating as a player, and wherein said processor is adapted to determine and track one or more of said characteristics during said game in substantially near-to-real time and to provide feedback to a user of corresponding game data.

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. The method of claim 34 of installing a performance monitoring system for edging sports in which a foot-worn boot attached to ground-engaging equipment is manipulated by a wearer of the boot to control digging of one of more edges of the ground-engaging equipment a ground surface beneath the wearer, the method comprising mounting a pair of a load cells in a position sandwiched between the boot and the ground-engaging equipment at respective positions arranged to underlie forefoot and heel areas of the boot to measure forces exerted on the ground engaging equipment by the wearer of the boot.

88. The method of claim 87 wherein the boot is an ice skating boot and the ground-engaging equipment comprises an ice skating blade and a blade holder supporting said ice skating blade on the boot, and the method comprises removing the blade holder from the boot, and mounting the measurement apparatuses to the underside of the boot in place of the blade holder.

89. The method of claim 87 wherein the boot is a ski boot and the ground-engaging equipment comprises a ski blade, and the method comprises removing a binding mechanism from the ski blade, and mounting the measurement apparatuses to an underside of the binding mechanism in place of the ski blade.

90. The method of claim 87 wherein the boot is a snowboard boot and the ground-engaging equipment comprises a snowboard deck, and the method comprises removing a binding mechanism from the snowboard deck, and mounting the measurement apparatuses to an underside of the binding mechanism in place of the snowboard deck.

91. The method of claim 87 wherein mounting the pair of a load cells comprises using existing fastening features on the ground engaging equipment.

92. The method of claim 34 of monitoring performance in edging sports in which a foot-worn boot attached to ground-engaging equipment is manipulated by a wearer of the boot to control digging of one of more edges of the ground-engaging equipment a ground surface beneath the wearer, the method comprising measuring separate loading conditions at heel and forefoot areas between the foot-worn boot and the ground engaging equipment and determining a distribution of total loading of the ground-engaging equipment between the heel and forefoot areas.
